(19) United States
(12) Patent Application Publication
(10) Pub. No.: US 2018/0105761 A1
(43) Pub. Date: Apr. 19, 2018

(54) LUBRICANT BASESTOCK PRODUCTION WITH ENHANCED AROMATIC SATURATION

(71) Applicant: ExxonMobil Research and Engineering Company, Annandale, NJ (US)

(72) Inventors: Jason T. Calla, Raritan, NJ (US); Ajit B. Dandekar, The Woodlands, TX (US); Scott J. Weigel, Allentown, PA (US); Darryl D. Lacy, Easton, PA (US); Wenyih F. Lai, Bridgewater, NJ (US); Sara L. Yohe, Raritan, NJ (US)

(21) Appl. No.: 15/715,555

(22) Filed: Sep. 26, 2017

Related U.S. Application Data
(60) Provisional application No. 62/408,142, filed on Oct. 14, 2016.

(51) Int. Cl. C10M 105/00; B01J 8/04; C10G 57/00; C10G 69/02

(52) U.S. Cl. CPC C10M 105/00; B01J 8/0492; C10G 57/00; C10G 2400/10; C10M 2203/003; C10G 2300/302; C10G 69/02

(57) ABSTRACT

Systems and methods are provided for producing lubricant basestocks using a process flow that includes a conversion catalyst that can provide a desired improvement in viscosity index at a reduced or minimized amount of feed conversion. An initial processing stage can be used to produce a lubricant boiling range fraction with a reduced or minimized heteroatom content. After a separation, at least a portion of the lubricant boiling range portion can be exposed to a conversion catalyst that has an effective pore size of at least 8.0 Angstroms, a total surface area of at least 200 m²/g, and/or an Alpha value of 20 or less, where the conversion catalyst includes a supported Group 8-10 noble metal. The methods can allow for increased yields of high viscosity index lubricant boiling range products from a process flow for lubricant base stock and/or blend stock production.

### CROSS-REFERENCE TO RELATED APPLICATIONS

This application claims priority to U.S. Provisional Application Ser. No. 62/408,142 filed Oct. 14, 2016, which is herein incorporated by reference in its entirety.

### FIELD

Systems and methods are provided that can offer enhanced selectivity for production of lubricant boiling range products during processing to form lubricant base stocks.

### BACKGROUND

One of the common methods for characterizing a lubricant base stock is based on the viscosity index (VI) of the base stock. When producing a lubricant base stock from a suitable feed, such as a vacuum gas oil boiling range feed, the VI can be increased during hydroprocessing. The amount of conversion performed on a feed, such as conversion relative to 371° C., can typically be used as an indication of process severity. The amount of VI uplift provided by various types of hydroprocessing can be roughly correlated with the process severity. However, the amount of VI uplift that can be provided is limited in a practical sense due in part to the inherent nature of an underlying feedstock, and due in part to the limitation that continuing to increase the conversion of a feed relative to 371° C. also results in continuing decreases in the yield of the 371° C.+ of the eventual product (i.e., the lubricant boiling range portion of the product).

U.S. Pat. No. 8,394,255 describes an integrated process for producing naphtha, diesel, and/or lubricant base stock boiling range products. The integrated process can include initial processes for hydrotreatment, hydrocracking, and/or catalytic dewaxing of a feed, followed by cascade of the resulting effluent to a catalytic dewaxing step for dewaxing under sour conditions. The hydrocracking and dewaxing catalysts can include base metals or can include Pd and/or Pt. An example of a hydrocracking catalyst is USY and an example of a dewaxing catalyst is ZSM-48.

U.S. Patent Application Publication 2013/0341243 describes a hydrocracking process selective for improved distillate and improved lube yield and properties. A two-stage hydrocracking catalyst can be used for hydrocracking of a feed to form a converted portion suitable for diesel fuel production and an unconverted portion suitable for production of lubricant base stocks. The two-stage hydrocracking catalyst can correspond to a first stage catalyst including Pd and/or Pt supported on USY and a second stage catalyst including Pd and/or Pt supported on ZSM-48.

U.S. Pat. No. 7,192,900 describes hydrocracking catalysts containing USY zeolite with surface areas of greater than about 800 m²/g. The hydrocracking catalysts are described as being selective for producing distillate fuel boiling range products, rather than naphtha and/or light ends, during a fuels hydrocracking process.

### SUMMARY

In an aspect, a method for producing a lubricant boiling range product is provided. The method can include converting a feedstock comprising a lubricant boiling range portion in the presence of a conversion catalyst under conversion conditions to form a converted effluent. The conversion catalyst can comprise a surface area of at least 200 m²/g and/or an Alpha value of 20 or less and/or an effective pore size of at least 8.0 Angstroms. Additionally or alternately, the conversion catalyst can comprise 0.01 wt % to 5.0 wt % of a Group 8-10 noble metal supported on the conversion catalyst. At least a portion of the converted effluent can be dewaxed under catalytic dewaxing conditions to form a dewaxed effluent. At least a portion of the dewaxed effluent can then be fractionated to form at least a lubricant boiling range product, and optionally a fuels boiling range product.

In some optional aspects, the conversion catalyst can comprise a surface area of at least 500 m²/g; or the conversion catalyst can comprise an Alpha value of 10 or less; or the conversion catalyst can comprise an effective pore size of at least 10 Angstroms; or a combination thereof. Optionally, the conversion catalyst can be substantially free of crystals having a zeolitic framework, such as substantially free of crystals with a 10-member ring pore channel and/or a 12-member ring pore channel. In some aspects, the conversion catalyst can include a mesoporous material, a mesoporous organosilicate, MCM-41, or a combination thereof. In some aspects, the Group 8-10 noble metal can correspond to Pt, Pd, or a combination thereof. Optionally, the conversion catalyst can further include an additional metal, such as Sn, Ga, Zn, Rh, or a combination thereof.

Optionally, the feedstock can include 50 wppm or less of sulfur and/or 50 wppm or less of nitrogen. Optionally, the feedstock can comprises a hydrotreated deasphalted oil, a feedstock having an aromatics content of about 25 wt % or less, or a combination thereof. In such optional aspects, the conversion catalyst can optionally include 0.1 wt % to 25 wt % of crystals having a zeolitic framework (or 0.1 wt % to 15 wt %). Optionally, the lubricant boiling range product can have an aromatics content of 2.0 wt % or less, a 3+ ring aromatics content of 0.1 wt % or less, or a combination thereof.

In some aspects, the method can further comprise hydrofinishing the dewaxed effluent (or at least a portion thereof) prior to the fractionating. In some aspects, the method can further comprise hydroprocessing a feed comprising a 650° F.+ (˜343° C.+) portion under first hydroprocessing conditions to form a hydroprocessed effluent; and fractionating at least a portion of the hydroprocessed effluent to form at least a first fuels boiling range fraction and a second fraction, the second fraction comprising the lubricant boiling range portion, the hydroprocessing the feedstock optionally comprising a) exposing the feedstock to a hydrotreating catalyst under hydrotreating conditions, b) exposing the feedstock to a hydrocracking catalyst under hydrocracking conditions, or c) a combination thereof.

In another aspect, a system for producing a lubricant boiling range product is provided. The system can include a hydrotreating reactor comprising a hydrotreating feed inlet, a hydrotreating effluent outlet, and at least one fixed catalyst bed comprising a hydrotreating catalyst. The system can further include a separation stage having a first separation stage inlet and a second separation stage inlet, the first separation stage inlet being in fluid communication with the hydrotreating effluent outlet, the separation stage further comprising a plurality of separation stage liquid effluent outlets, one or more of the separation stage liquid effluent outlets corresponding to product outlets. The system can further include a conversion reactor comprising a conversion feed inlet, a converted effluent outlet, and at least one fixed catalyst bed comprising a conversion catalyst, the conversion feed inlet being in fluid communication with at least one separation stage liquid effluent outlet. The conversion catalyst can include a surface area of at least 200 m²/g (or at least 400 m²/g), an Alpha value of 20 or less, and an effective pore size of at least 8.0 Angstroms. The conversion catalyst can further include 0.01 wt % to 5.0 wt % of a Group 8-10 noble metal supported on the conversion catalyst (or 0.1 wt % to 5.0 wt %). The system can further include a dewaxing reactor comprising a dewaxing feed inlet, a dewaxing effluent outlet, and at least one fixed catalyst bed comprising a dewaxing catalyst, the dewaxing feed inlet being in fluid communication with the converted effluent outlet and being in fluid communication with the dewaxing effluent outlet.

Optionally, the dewaxing reactor can further include a fixed bed comprising a hydrofinishing catalyst, wherein the hydrotreating reactor further comprises a fixed bed comprising a hydrocracking catalyst, or a combination thereof. Additionally or alternately, the system can further include a hydrofinishing reactor comprising a hydrofinishing feed inlet, a hydrofinishing effluent outlet, and at least one fixed catalyst bed comprising a hydrofinishing catalyst, the hydrofinishing feed inlet being in direct fluid communication with the dewaxing feed outlet, the dewaxing feed inlet being in direct fluid communication with the hydrofinishing effluent outlet and in indirect fluid communication with the dewaxing effluent outlet. Additionally or alternately, the system can further include an additional hydrocracking reactor comprising an additional hydrocracking feed inlet, an additional hydrocracking effluent outlet, and at least one fixed catalyst bed comprising an additional hydrocracking catalyst, the additional hydrocracking reactor providing indirect fluid communication between the hydrotreating effluent outlet and the first separation stage inlet, the additional hydrocracking feed inlet being in fluid communication with the hydrotreating effluent outlet, the additional hydrocracking effluent outlet being in fluid communication with the first separation stage inlet.

In still another aspect, a converted, deasphalted oil composition is provided, the composition including a 510° C.+ portion having a viscosity index of 115 to 140, a total aromatics content of 0.5 wt % or less, and a 3+ ring aromatics content of 0.1 wt % or less; and a 371° C.-510° C. portion having a viscosity index of at least 110 and that is less than the viscosity index of the 510° C.+ portion, a total aromatics content 0.5 wt % or less, and a 3+ ring aromatics content of 0.1 wt % or less.

### BRIEF DESCRIPTION OF THE DRAWINGS

FIG. 1 shows estimated viscosity index values for lubricant boiling range products produced by conversion over various catalysts at various amounts of conversion relative to 371° C.

FIG. 2 shows estimated viscosity index values for lubricant boiling range products produced by conversion over various catalysts at various amounts of conversion relative to 371° C.

FIG. 3 shows estimated viscosity index values for lubricant boiling range products produced by conversion over various catalysts at various amounts of conversion relative to 371° C.

FIG. 4 shows estimated viscosity index values for lubricant boiling range products produced by conversion over various catalysts at various amounts of conversion relative to 371° C.

FIG. 5 shows estimated viscosity index values for lubricant boiling range products produced by conversion over various catalysts at various amounts of conversion relative to 371° C.

FIG. 6 shows aromatics contents for lubricant boiling range products produced by conversion over various catalysts at various temperatures.

FIG. 7 shows aromatics contents for lubricant boiling range products produced by conversion over various catalysts at various temperatures.

FIG. 8 shows aromatics contents for lubricant boiling range products produced by conversion over various catalysts at various temperatures.

FIG. 9 shows aromatics contents for lubricant boiling range products produced by conversion over various catalysts at various temperatures.

FIG. 10 shows aromatics contents for lubricant boiling range products produced by conversion over various catalysts at various temperatures.

FIG. 11 shows aromatics contents for lubricant boiling range products produced by conversion over various catalysts at various temperatures.

FIG. 12 shows aromatics contents for lubricant boiling range products produced by conversion over various catalysts at various temperatures.

FIG. 13 shows aromatics contents for lubricant boiling range products produced by conversion over various catalysts at various temperatures.

FIG. 14 schematically shows an example of a configuration suitable for processing a feedstock to form at least a lubricant boiling range fraction.

### DETAILED DESCRIPTION

### Overview

All numerical values within the detailed description and the claims herein are modified by “about” or “approximately” the indicated value, and take into account experimental error and variations that would be expected by a person having ordinary skill in the art.

In various aspects, systems and methods are provided for producing lubricant basestocks using a process flow that includes a conversion catalyst that can provide a desired improvement in viscosity index at a reduced or minimized amount of feed conversion. An initial processing stage can be used to produce a lubricant boiling range fraction with a reduced or minimized heteroatom content. After a separation, at least a portion of the lubricant boiling range fraction can be exposed to a conversion catalyst that has an effective pore size of at least 8.0 Angstroms, a total surface area of at least 200 m²/g, and/or an Alpha value of 20 or less, where the conversion catalyst includes a supported Group 8-10 noble metal (based on the numbering from the IUPAC periodic table). In aspects where a conversion catalyst has an effective pore size is between 8.0-10 Angstroms, the total surface area can be still higher, such as at least 600 m²/g, or at least 700 m²/g. For aspects where a conversion catalyst has a larger pore size, smaller total surface areas can potentially be suitable. Performing conversion under sweet conditions in the presence of a high surface area conversion catalyst can result in a desired amount of viscosity index uplift while reducing or minimizing the amount of feed conversion to components outside of the lubricant boiling range. This can allow for increased yields of high viscosity index lubricant boiling range products from a process flow for lubricant base stock and/or blend stock production.

Traditionally, hydrocracking can be used as a method for producing a lubricant boiling range product with an increased viscosity index relative to the viscosity index of the feed. Under conventional understanding, the amount of viscosity index uplift can be related to the amount of feed conversion, such as conversion relative to 700° F. (371° C.). According to such conventional understanding, the conversion catalysts described herein can be considered less desirable when attempting to perform conversion, as the catalysts described herein can require a higher temperature to achieve a desired level of conversion. However, it has been discovered that the catalysts described herein having a high surface area and low Alpha value can provide greater increases in viscosity index at a given level of conversion. Thus, in spite of the apparent lower activity based on the amount of feed conversion, the conversion catalysts described herein can have improved activity for increasing viscosity index.

In this discussion, the naphtha boiling range is defined as 50° F. (˜10° C., roughly corresponding to the lowest boiling point of a pentane isomer) to 315° F. (157° C.). The jet boiling range is defined as 315° F. (157° C.) to 460° F. (238° C.). The diesel boiling range is defined as 460° F. (238° C.) to 650° F. (343° C.). The distillate fuel boiling range (jet plus diesel), is defined as 315° F. (157° C.) to 650° F. (343° C.). The fuels boiling range is defined as ˜10° C. to 343° C. The lubricant boiling range is defined as 650° F. (343° C.) to 1050° F. (566° C.). Optionally, when forming a lubricant boiling portion by fractionation after one or more stages of hydroprocessing (e.g., hydrotreating, hydrocracking, catalytic dewaxing, hydrofinishing), a lubricant boiling range portion can optionally correspond to a bottoms fraction, so that higher boiling range compounds may also be included in the lubricant boiling range portion. Compounds (C₄₋) with a boiling point below the naphtha boiling range can be referred to as light ends. It is noted that due to practical consideration during fractionation (or other boiling point based separation) of hydrocarbon-like fractions, a fuel fraction formed according to the methods described herein may have T5 and T95 distillation points corresponding to the above values (or T10 and T90 distillation points), as opposed to having initial/final boiling points corresponding to the above values.

In this discussion, conditions may be provided for various types of hydroprocessing of feeds or effluents. Examples of hydroprocessing can include, but are not limited to, one or more of hydrotreating, hydrocracking, catalytic dewaxing, and hydrofinishing/aromatic saturation. Such hydroprocessing conditions can be controlled to have desired values for the conditions (e.g., temperature, pressure, LHSV, treat gas rate) by using at least one controller, such as a plurality of controllers, to control one or more of the hydroprocessing conditions. In some aspects, for a given type of hydroprocessing, at least one controller can be associated with each type of hydroprocessing condition. In some aspects, one or more of the hydroprocessing conditions can be controlled by an associated controller. Examples of structures that can be controlled by a controller can include, but are not limited to, valves that control a flow rate, a pressure, or a combination thereof; heat exchangers and/or heaters that control a temperature; and one or more flow meters and one or more associated valves that control relative flow rates of at least two flows. Such controllers can optionally include a controller feedback loop including at least a processor, a detector for detecting a value of a control variable (e.g., temperature, pressure, flow rate, and a processor output for controlling the value of a manipulated variable (e.g., changing the position of a valve, increasing or decreasing the duty cycle and/or temperature for a heater). Optionally, at least one hydroprocessing condition for a given type of hydroprocessing may not have an associated controller.

Group I base stocks or base oils are defined as base stocks with less than 90 wt % saturated molecules and/or at least 0.03 wt % sulfur content. Group I base stocks also have a viscosity index (VI) of at least 80 but less than 120. Group II base stocks or base oils contain at least 90 wt % saturated molecules and less than 0.03 wt % sulfur. Group II base stocks also have a viscosity index of at least 80 but less than 120. Group III base stocks or base oils contain at least 90 wt % saturated molecules and less than 0.03 wt % sulfur, with a viscosity index of at least 120.

In some aspects, a Group III base stock as described herein may correspond to a Group III+ base stock. Although a generally accepted definition is not available, a Group III+ base stock can generally correspond to a base stock that satisfies the requirements for a Group III base stock while also having at least one property that is enhanced relative to a Group III specification. The enhanced property can correspond to, for example, having a viscosity index that is substantially greater than the required specification of 120, such as a Group III base stock having a VI of at least 130, or at least 135, or at least 140. Similarly, in some aspects, a Group II base stock as described herein may correspond to a Group II+ base stock. Although a generally accepted definition is not available, a Group II+ base stock can generally correspond to a base stock that satisfies the requirements for a Group II base stock while also having at least one property that is enhanced relative to a Group II specification. The enhanced property can correspond to, for example, having a viscosity index that is substantially greater than the required specification of 80, such as a Group II base stock having a VI of at least 103, or at least 108, or at least 113.

### High Surface Area, Low Acidity Hydrocracking Catalysts

A conversion catalyst with improved activity for viscosity index uplift while reducing or minimizing conversion can correspond to a high surface area, low acidity catalyst with an effective pore size of at least 8.0 Angstroms.

Some hydrocracking catalysts can correspond to catalysts with a large number of acidic sites and/or high acidity. Conventionally, acidic sites are believed to correspond to sites for hydrocracking activity. The acid sites/acidity of a catalyst can be determined using the Alpha value test. The Alpha value test is a measure of the cracking activity of a catalyst and is described in U.S. Pat. No. 3,354,078 and in the Journal of Catalysis, Vol. 4, p. 527 (1965); Vol. 6, p. 278 (1966); and Vol. 61, p. 395 (1980), each incorporated herein by reference as to that description. The experimental conditions of the test used herein include a constant temperature of 538° C. and a variable flow rate as described in detail in the Journal of Catalysis, Vol. 61, p. 395. Catalysts that are conventionally believed to be suitable for hydrocracking can have Alpha values of at least about 25, or at least about 50, or at least about 100. Such catalysts can include amorphous catalysts, such as amorphous silica-alumina or alumina.

Other conventional hydrocracking catalysts can generally correspond to catalysts with high activity for conversion of a feed relative to a conversion temperature of 371° C. Some conventional hydrocracking catalysts can include a structure having a zeolitic framework (i.e., a framework recognized by the International Zeolite Association), with the zeolitic framework including a pore channel corresponding to a 10-member or 12-member ring in the framework. Such catalysts can optionally also include a binder. Examples of this type of hydrocracking catalyst include catalysts based on a structure having a MFI framework (such as ZSM-5), a ZSM-48 type framework, or a FAU (such as Y zeolite) framework.

The above types of conventional catalysts are believed to be beneficial for allowing increased conversion of a feed relative to the hydrocracking temperature. Having increased conversion at a given temperature can provide flexibility for the processing conditions, so that the hydrocracking temperature can be adjusted to provide a desired level of conversion and/or VI uplift.

In contrast to the above conventional hydrocracking catalysts, it has been discovered that an improved combination of VI uplift and yield of lubricant boiling range products can be achieved using catalysts having a different set of characteristics. The catalysts providing an improved combination of VI uplift and yield of lubricant boiling range products can correspond to catalysts having a high surface area and/or a low Alpha value. Catalysts having a high surface area can correspond to catalysts with a total surface area of at least 200 m²/g as determined by BET adsorption (N₂), or at least 300 m²/g, or at least 400 m²/g, at least 500 m²/g, or at least 600 m²/g, or at least 700 m²/g, such as up to 1200 m²/g or more, or up to 1500 m²/g or more. In particular, a catalyst can have a total surface area of 200 m²/g to 1500 m²/g, or 400 m²/g to 1500 m²/g, or 600 m²/g to 1500 m²/g, or 700 m²/g to 1200 m²/g. Catalysts having a low Alpha value can correspond to catalysts with an Alpha value of 20 or less, or 10 or less, or 5 or less, such as down to an Alpha value of 0.5 or possibly lower. Additionally, the high total surface area and/or low Alpha value catalysts can include a Group VIII noble metal (including a combination of such noble metals) as a hydrogenation metal.

The catalysts having an improved combination of VI uplift and yield of lubricant boiling range products can also have an effective pore size of at least 8.0 Angstroms. The pore size distribution (such as pore width) relative to the pore volume of a catalyst can be determined using BET adsorption with N₂ as the adsorbed molecule. The effective pore size can be defined based on the substantial pore size peak in the pore size distribution (such as pore width distribution) corresponding to the smallest median pore size. A substantial pore size peak is defined herein as a peak in a pore size distribution corresponding to at least 10 vol % of the pore volume. The pore size corresponding to a maximum height of a pore size peak in the pore size distribution can be referred to as a median pore size. The width of a pore size peak can be characterized based on the width of a pore size peak at half of the maximum height. Depending on the aspect, a catalyst can have an effective pore size of at least 8.0 Angstroms, or at least 10 Angstroms, or at least 12 Angstroms, such as up to 100 Angstroms or more.

In some aspects, a catalyst with a smaller effective pore size, such as an effective pore size of 8.0 Angstroms to 12 Angstroms, or 8.0 Angstroms to 10 Angstroms, can have a corresponding higher total surface area, such as 600 m²/g to 1500 m²/g, or 700 m²/g to 1500 m²/g, or 600 m²/g to 1200 m²/g. In other aspects, a catalyst with an effective pore size of at least 10 Angstroms, or at least 12 Angstroms (such as 10 to 100 Angstroms or 12 to 100 Angstroms) can have a total surface area of 200 m ²/g to 1500 m²/g, or 400 m²/g to 1200 m²/g, or 500 m²/g to 1000 m²/g.

Without being bound by any particular theory, it is believed that high surface area, low acidity hydrocracking catalysts as described herein can have increased selectivity for cracking of multi-ring compounds, and in particular selectivity for cracking of 3+ ring compounds such as 3+ ring aromatics. In a vacuum gas oil boiling range feed, it is believed that an increased selectivity for cracking large multi-ring compounds can allow for improvements in the viscosity index of a hydrocracked feed while reducing or minimizing cracking of lower boiling compounds. As a result, even though conversion of the feed relative to 371° C. may be reduced at a given set of conversion conditions, the amount of viscosity index uplift can be increased relative to the amount of conversion.

Examples of materials that can have a high surface area include, but are not limited to, mesoporous aluminosilicates (e.g., MCM-41 or MCM-48), mesoporous organosilicas (MOS), periodic mesoporous organosilicas (PMO), SBA-15, KIT-6, ERS-8, hexagonal mesoporous silica (HMS), pre-zeolitic materials, mesoporous silicas (including MSU-H and/or mesoporous silicas doped with metals to incorporate acidity), aluminosilicate gels (such as Sorbead®), silica-alumina hydrates (such as SIRAL®), amorphous alumina, amorphous silica, amorphous silica-alumina, and ion exchange resin silica/silicone supports. Optionally, the acidity of a material can be modified, such as by introducing one or more metals and/or metal oxides. Examples of suitable metals (in their metallic state) and/or metal oxides that can be included in a material to adjust acidity (either increase or decrease) can include, but are not limited to, metals and/or corresponding oxides of titanium, tin, vanadium, iron, cobalt, nickel, zinc, manganese, cerium, lanthanum, and yttrium. Optionally, the acidity can be modified by introducing a mixture of one or more metals, one or more metal oxides, or a mixture of at least one metal and at least one metal oxide. For example, acidity modification can be performed by introducing WOₓ, W/Zr, and/or sulfated zirconias onto silica materials.

In some aspects, the catalysts described herein can have a reduced or minimized content of conventional hydrocracking catalyst structures based on zeolitic frameworks. For example, a catalyst having a high surface area and/or low Alpha value can include 25 wt % or less, or 15 wt % or less, or 1.0 wt % or less, or 0.1 wt % or less, such as down to 0 wt %, of crystalline zeolitic structure(s) having a 10-member ring or 12-member ring pore channel. In some alternative aspects, a catalyst having a high surface area and/or low Alpha value can include still higher amounts of crystalline zeolitic structures having a 10-member ring or 12-member ring pore channel, such as 50 wt % or less, or 35 wt % or less, or 20 wt % or less. Catalysts having less than 0.1 wt % of zeolitic structures having a 10-member ring or 12-member pore channel can correspond to catalysts that are substantially free of such zeolitic structures. Additionally or alternately, a catalyst can include 25 wt % or less, or 15 wt % or less, or 1.0 wt % or less, or 0.1 wt % or less, such as down to 0 wt %, of a (crystalline) zeolitic structure having a framework type recognized by the International Zeolite Association. In some alternative aspects, a catalyst can include still higher amounts of crystalline zeolitic structures, such as 50 wt % or less, or 35 wt % or less, or 20 wt % or less. In some aspects, the amount of catalyst based on a zeolitic framework (such as a zeolitic catalyst having a 10-member ring or 12-member ring pore channel) can be dependent on the nature of the feed. For feeds having an aromatics content of 0 wt % to 25 wt %, or 1 wt % to 20 wt %, or 0 wt % to 15 wt %, a conversion catalyst can include 25 wt % or less of a zeolitic structure (such as a zeolitic structure having a 10-member or 12-member ring pore channel, and/or a zeolitic structure having a 10-member or larger ring pore channel), or 15 wt % or less, or 10 wt % or less. In other words, the zeolitic structure content can be 0 wt % to 25 wt %, or 0.1 wt % to 25 wt %, or 0.1 wt % to 15 wt %, or 0.1 wt % to 10 wt %. For feeds having an aromatics content greater than 25 wt %, such as 25 wt % to 100 wt %, or 25 wt % to 75 wt %, or 35 wt % to 100 wt %, or 35 wt % to 75 wt %, a conversion catalyst can include 5.0 wt % or less of a zeolitic structure (such as a zeolitic structure having a 10-member or 12-member ring pore channel), or 1.0 wt % or less, or 0.1 wt % or less. In other words, the zeolitic structure content can be 0 wt % to 5.0 wt %, or 0 wt % to 1.0 wt %, or 0 wt % to 0.1 wt %, or 0.1 wt % to 5.0 wt %.

Some types of materials that can provide high surface areas when formulated into catalysts can correspond to mesoporous materials, which correspond to materials where a substantial portion of the pore volume of the material corresponds to pores having a pore size of 15 Angstroms or more. A substantial portion of the pore volume can correspond to a material where at least 40% of the pore volume corresponds to pores having a pore size of 15 Angstroms or more, or at least 50%, or at least 70%. Examples of mesoporous materials can include, but are not limited to, mesoporous silicas, MCM-41, and aluminosilicates and/or other isomorphous substituted materials having a framework structure corresponding to MCM-41.

In some aspects, mesoporosity can be introduced into a catalyst by a treatment after formation of catalyst particles. For example, dealumination of a silicoaluminate can potentially add mesoporosity to a silicoaluminate material. The dealumination can be based on steaming of catalyst particles and/or chemical dealumination. Similarly, desilication of a silicon-containing catalyst particle can potentially lead to mesoporosity.

In some aspects, a high surface area catalyst can correspond to a catalyst composed of agglomerates of particles where the high surface area is substantially due to exposed surface area between particles in a catalyst. In such aspects, at least 50% of the surface area can correspond to surface area at the exterior of the particles comprising a catalyst (i.e., not within a pore of a particle), or at least 70%, or at least 90%.

In some aspects, a high surface area, low acidity catalyst can correspond to a material formed by co-precipitation of silica with one or more amorphous metal oxide precursors. This can allow for formation of mixed metal oxides having high surface area. In some aspects, a high surface area, low acidity catalyst can correspond to a crystalline material that contains silica and one or more additional types of metal oxides, such as Al₂O₃, B₂O₃, Ga₂O₃, ZnO, and/or TiO₂. This type of addition of metal oxides can increase the acidity of the crystalline material. The material with increased acidity can still preferably have an Alpha value of less than 20, or less than 10, or less than 5. The ratio of silica to other metal oxides (by weight) in the crystalline material can be from 10 to 500.

In some aspects, a high surface area, low acidity catalyst can correspond to a bound catalyst. When a binder is included, the binder can correspond to an acidic or basic material. The binder can correspond to a higher surface area material than other materials in the catalyst, or the binder can be lower in surface area. In some aspects, the catalyst can be a self-bound catalyst and/or a catalyst without a binder. Examples of binder materials can include, but are not limited to, various types of oxides of aluminum, lanthanum, magnesium, silicon, zinc, boron, titanium, zirconium, yttrium, hafnium, tungsten, molybdenum, cerium, manganese, cobalt, iron, nickel, and combinations thereof.

A high surface area, low acidity catalyst can include one or more catalytic metals supported on the catalyst that can serve as hydrogenation metals. The hydrogenation metals supported on the catalyst can optionally be in oxide or sulfide form during hydrocracking. Examples of suitable catalytic metals can include Pt, Pd, Ni, W, Mo, Co, Sn, Cu, Ru, Rh, Ir, Re, and combinations thereof. In some aspects, the one or more catalytic metals can correspond to Group VIII metals and/or noble metals. For example, the one or more catalytic metals can correspond to Pt, Pd, or a combination thereof. In other examples, a catalyst that includes a noble metal as a hydrogenation metal can correspond to a catalyst that includes a mixture of metals. Suitable mixtures of metals can include, but are not limited to, Pt/Pd, Pt/Sn, Pt/Ga, Pt/Zn, Pt/Rh, Pd/Sn, Pd/Ga, Pd/Zn, and Pd/Rh. The amount of hydrogenation metal in the catalyst can be at least 0.01 wt % based on catalyst, or at least 0.1 wt %, or at least 0.15 wt %, or at least 0.2 wt %, or at least 0.25 wt %, or at least 0.3 wt %, or at least 0.5 wt % based on the catalyst. In aspects where the hydrogenation metal corresponds to and/or includes one or more Group VIII noble metals, the amount of Group VIII noble metal can be from 0.01 wt % to 5 wt %, or from 0.1 wt % to 4 wt %, or from 0.3 wt % to 3.5 wt %. In aspects where the hydrogenation metal corresponds to at least one base metal, the amount of hydrogenation metal can be from 1.0 wt % to 30 wt %.

The resulting lubricant boiling range fraction formed by hydrocracking with a high surface area, low acidity catalyst can be subsequently catalytically dewaxed and/or hydrofinished to form one or more lubricant boiling range products. The lubricant boiling range fraction can have a reduced or minimized content of aromatics, as well as a reduced or minimized content of 3+ ring aromatics. In various aspects, the total aromatics content can be 2.0 wt % or less, or 1.5 wt % or less, or 1.0 wt % or less. In various aspects, the 3+ ring aromatics content can be 0.2 wt % or less, or 0.1 wt % or less, or 0.05 wt % or less. Aromatics content can be determined by any convenient method, such as by characterization using UV spectroscopy. ASTM D2008 provides one example of a method for correlating data generated from UV/VIS spectroscopy with a weight of aromatics present in a sample.

### Configuration Example

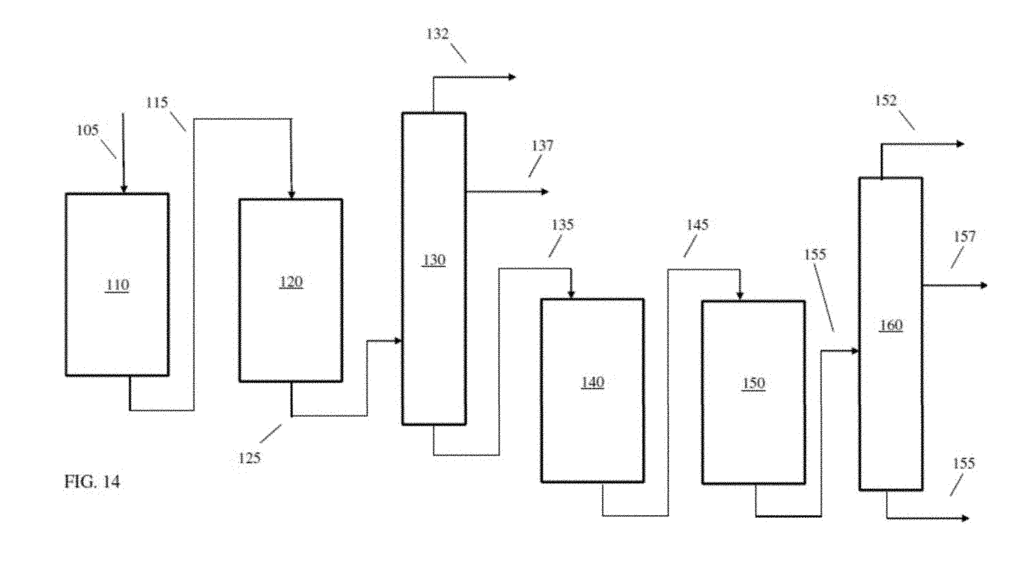

FIG. 14 shows an example of a general processing configuration suitable for processing a feedstock to produce distillate fuels. In FIG. 14, a feedstock 105 can be introduced into a first reactor 110. A reactor such as first reactor 110 can include a feed inlet and an effluent outlet. First reactor 110 can correspond to a hydrotreating reactor, a hydrocracking reactor, or a combination thereof. Optionally, a plurality of reactors can be used to allow for selection of different conditions. For example, if both a first reactor 110 and optional second reactor 120 are included in the reaction system, first reactor 110 can correspond to a hydrotreatment reactor while second reactor 120 can correspond to a hydrocracking reactor. Yet other options for arranging reactor(s) and/or catalysts within the reactor(s) to perform initial hydrotreating and/or hydrocracking of a feedstock can also be used. Optionally, if a configuration includes multiple reactors in the initial stage, a gas-liquid separation can be performed between reactors to allow for removal of light ends and contaminant gases. In aspects where the initial stage includes a hydrocracking reactor, the hydrocracking reactor in the initial stage can be referred to as an additional hydrocracking reactor.

The hydroprocessed effluent 125 from the final reactor (such as reactor 120) of the initial stage can then be passed into a fractionator 130, or another type of separation stage. Fractionator 130 (or other separation stage) can separate the hydroprocessed effluent to form one or more fuel boiling range fractions 137, a light ends fraction 132, and a lubricant boiling range fraction 135. The lubricant boiling range fraction 135 can often correspond to a bottoms fraction from the fractionator 130. The lubricant boiling range fraction 135 can undergo further hydrocracking in the presence of a USY zeolite in second stage hydrocracking reactor 140. The effluent 145 from second stage hydrocracking reactor 140 can then be passed into a dewaxing/hydrofinishing reactor 150 to further improve the properties of the eventually produced lubricant boiling range products. In the configuration shown in FIG. 14, the effluent 155 from second stage dewaxing/hydrofinishing reactor 150 can be fractionated 160 to separate out light ends 152 and/or fuel boiling range fraction(s) 157 from one or more desired lubricant boiling range fractions 155.

The configuration in FIG. 14 can allow the second stage hydrocracking reactor 140 and the dewaxing/hydrofinishing reactor 150 to be operated under sweet processing conditions, corresponding to the equivalent of a feed (to the second stage) sulfur content of 100 wppm or less. Under such “sweet” processing conditions, the configuration in FIG. 14, in combination with use of a high surface area, low acidity catalyst, can allow for production of a hydrocracked effluent having a reduced or minimized content of aromatics.

In the configuration shown in FIG. 14, the final reactor in (such as reactor 120) in the initial stage can be referred to as being in direct fluid communication with an inlet to the fractionator 130 (or an inlet to another type of separation stage). The other reactors in the initial stage can be referred to as being in indirect fluid communication with the inlet to the separation stage, based on the indirect fluid communication provided by the final reactor in the initial stage. The reactors in the initial stage can generally be referred to as being in fluid communication with the separation stage, based on either direct fluid communication or indirect fluid communication. In some optional aspects, one or more recycle loops can be included as part of a reaction system configuration. Recycle loops can allow for quenching of effluents between reactors/stages as well as quenching within a reactor/stage.

### Feedstocks

A wide range of petroleum and chemical feedstocks can be hydroprocessed in accordance with the invention. Suitable feedstocks include whole and reduced petroleum crudes, atmospheric, cycle oils, gas oils, including vacuum gas oils and coker gas oils, light to heavy distillates including raw virgin distillates, hydrocrackates, hydrotreated oils, petroleum-derived waxes (including slack waxes), Fischer-Tropsch waxes, raffinates, deasphalted oils, and mixtures of these materials.

One way of defining a feedstock is based on the boiling range of the feed. One option for defining a boiling range is to use an initial boiling point for a feed and/or a final boiling point for a feed. Another option is to characterize a feed based on the amount of the feed that boils at one or more temperatures. For example, a “T5” boiling point/distillation point for a feed is defined as the temperature at which 5 wt % of the feed will boil off. Similarly, a “T95” boiling point/distillation point is a temperature at 95 wt % of the feed will boil. Boiling points, including fractional weight boiling points, can be determined using an appropriate ASTM test method, such as the procedures described in ASTM D2887, D2892, D6352, D7129, and/or D86.

Typical feeds include, for example, feeds with an initial boiling point and/or a T5 boiling point and/or T10 boiling point of at least 600° F. (˜316° C.), or at least 650° F. (˜343° C.), or at least 700° F. (371° C.), or at least 750° F. (˜399° C.). Additionally or alternately, the final boiling point and/or T95 boiling point and/or T90 boiling point of the feed can be 1100° F. (˜593° C.) or less, or 1050° F. (˜566° C.) or less, or 1000° F. (˜538° C.) or less, or 950° F. (˜510° C.) or less. In particular, a feed can have a T5 boiling point of at least 600° F. (˜316° C.) and a T95 boiling point of 1100° F. (˜593° C.) or less, or a T5 boiling point of at least 650° F. (˜343° C.) and a T95 boiling point of 1050° F. (˜566° C.) or less, or a T10 boiling point of at least 650° F. (˜343° C.) and a T90 boiling point of 1050° F. (˜566° C.) or less. Optionally, if the hydroprocessing is also used to form fuels, it can be possible to use a feed that includes a lower boiling range portion. Such a feed can have an initial boiling point and/or a T5 boiling point and/or T10 boiling point of at least 350° F. (˜177° C.), or at least 400° F. (˜204° C.), or at least 450° F. (˜232° C.). In particular, such a feed can have a T5 boiling point of at least 350° F. (˜177° C.) and a T95 boiling point of 1100° F. (˜593° C.) or less, or a T5 boiling point of at least 450° F. (˜232° C.) and a T95 boiling point of 1050° F. (˜566° C.) or less, or a T10 boiling point of at least 350° F. (˜177° C.) and a T90 boiling point of 1050° F. (˜566° C.) or less.

In some aspects, the aromatics content of the feed can be at least 20 wt %, or at least 25 wt %, or at least 30 wt %, or at least 40 wt %, or at least 50 wt %, or at least 60 wt %, such as up to 75 wt % or up to 90 wt %. In particular, the aromatics content can be 25 wt % to 75 wt %, or 25 wt % to 90 wt %, or 35 wt % to 75 wt %, or 35 wt % to 90 wt %. In other aspects, the feed can have a lower aromatics content, such as an aromatics content of 35 wt % or less, or 25 wt % or less, such as down to 0 wt %. In particular, the aromatics content can be 0 wt % to 35 wt %, or 0 wt % to 25 wt %, or 5.0 wt % to 35 wt %, or 5.0 wt % to 25 wt %.

In aspects where the hydroprocessing includes a hydrotreatment process and/or a sour hydrocracking process, the feed can have a sulfur content of 500 wppm to 20000 wppm or more, or 500 wppm to 10000 wppm, or 500 wppm to 5000 wppm. Additionally or alternately, the nitrogen content of such a feed can be 20 wppm to 4000 wppm, or 50 wppm to 2000 wppm. In some aspects, the feed can correspond to a “sweet” feed, so that the sulfur content of the feed is 10 wppm to 500 wppm and/or the nitrogen content is 1 wppm to 100 wppm.

In some embodiments, at least a portion of the feed can correspond to a feed derived from a biocomponent source. In this discussion, a biocomponent feedstock refers to a hydrocarbon feedstock derived from a biological raw material component, from biocomponent sources such as vegetable, animal, fish, and/or algae. Note that, for the purposes of this document, vegetable fats/oils refer generally to any plant based material, and can include fat/oils derived from a source such as plants of the genus Jatropha. Generally, the biocomponent sources can include vegetable fats/oils, animal fats/oils, fish oils, pyrolysis oils, and algae lipids/oils, as well as components of such materials, and in some embodiments can specifically include one or more type of lipid compounds. Lipid compounds are typically biological compounds that are insoluble in water, but soluble in nonpolar (or fat) solvents. Non-limiting examples of such solvents include alcohols, ethers, chloroform, alkyl acetates, benzene, and combinations thereof.

First Hydroprocessing Stage—Hydrotreating and/or Hydrocracking

In various aspects, a first hydroprocessing stage can be used to improve one or more qualities of a feedstock for lubricant base oil production. Examples of improvements of a feedstock can include, but are not limited to, reducing the heteroatom content of a feed, performing conversion on a feed to provide viscosity index uplift, and/or performing aromatic saturation on a feed.

With regard to heteroatom removal, the conditions in the initial hydroprocessing stage (hydrotreating and/or hydrocracking) can be sufficient to reduce the sulfur content of the hydroprocessed effluent to 250 wppm or less, or 200 wppm or less, or 150 wppm or less, or 100 wppm or less, or 50 wppm or less, or 25 wppm or less, or 10 wppm or less. In particular, the sulfur content of the hydroprocessed effluent can be 1 wppm to 250 wppm, or 1 wppm to 50 wppm, or 1 wppm to 10 wppm. Additionally or alternately, the conditions in the initial hydroprocessing stage can be sufficient to reduce the nitrogen content to 100 wppm or less, or 50 wppm or less, or 25 wppm or less, or 10 wppm or less. In particular, the nitrogen content can be 1 wppm to 100 wppm, or 1 wppm to 25 wppm, or 1 wppm to 10 wppm.

In aspects that include hydrotreating as part of the initial hydroprocessing stage, the hydrotreating catalyst can comprise any suitable hydrotreating catalyst, e.g., a catalyst comprising at least one Group 8-10 non-noble metal (for example selected from Ni, Co, and a combination thereof) and at least one Group 6 metal (for example selected from Mo, W, and a combination thereof), optionally including a suitable support and/or filler material (e.g., comprising alumina, silica, titania, zirconia, or a combination thereof). The hydrotreating catalyst according to aspects of this invention can be a bulk catalyst or a supported catalyst. Techniques for producing supported catalysts are well known in the art. Techniques for producing bulk metal catalyst particles are known and have been previously described, for example in U.S. Pat. No. 6,162,350, which is hereby incorporated by reference. Bulk metal catalyst particles can be made via methods where all of the metal catalyst precursors are in solution, or via methods where at least one of the precursors is in at least partly in solid form, optionally but preferably while at least another one of the precursors is provided only in a solution form. Providing a metal precursor at least partly in solid form can be achieved, for example, by providing a solution of the metal precursor that also includes solid and/or precipitated metal in the solution, such as in the form of suspended particles. By way of illustration, some examples of suitable hydrotreating catalysts are described in one or more of U.S. Pat. Nos. 6,156,695, 6,162,350, 6,299,760, 6,582,590, 6,712,955, 6,783,663, 6,863,803, 6,929,738, 7,229,548, 7,288,182, 7,410,924, and 7,544,632, U.S. Patent Application Publication Nos. 2005/0277545, 2006/0060502, 2007/0084754, and 2008/0132407, and International Publication Nos. WO 04/007646, WO 2007/084437, WO 2007/084438, WO 2007/084439, and WO 2007/084471, inter alia. Preferred metal catalysts include cobalt/molybdenum (1-10% Co as oxide, 10-40% Mo as oxide), nickel/molybdenum (1-10% Ni as oxide, 10-40% Co as oxide), or nickel/tungsten (1-10% Ni as oxide, 10-40% W as oxide) on alumina.

In various aspects, hydrotreating conditions can include temperatures of 200° C. to 450° C., or 315° C. to 425° C.; pressures of 250 psig (˜1.8 MPag) to 5000 psig (˜34.6 MPag) or 500 psig (˜3.4 MPag) to 3000 psig (˜20.8 MPag), or 800 psig (˜5.5 MPag) to 2500 psig (˜17.2 MPag); Liquid Hourly Space Velocities (LHSV) of 0.2-10 h⁻¹; and hydrogen treat rates of 200 scf/B (35.6 m³/m³) to 10,000 scf/B (1781 m³/m³), or 500 (89 m³/m³) to 10,000 scf/B (1781 m³/m³).

Hydrotreating catalysts are typically those containing Group 6 metals, and non-noble Group 8-10 metals, i.e., iron, cobalt and nickel and mixtures thereof These metals or mixtures of metals are typically present as oxides or sulfides on refractory metal oxide supports. Suitable metal oxide supports include low acidic oxides such as silica, alumina or titania, preferably alumina. In some aspects, preferred aluminas can correspond to porous aluminas such as gamma or eta having average pore sizes from 50 to 200 Å, or 75 to 150 Å; a surface area from 100 to 300 m²/g, or 150 to 250 m²/g; and/or a pore volume of from 0.25 to 1.0 cm³/g, or 0.35 to 0.8 cm³/g. The supports are preferably not promoted with a halogen such as fluorine as this generally increases the acidity of the support.

Alternatively, the hydrotreating catalyst can be a bulk metal catalyst, or a combination of stacked beds of supported and bulk metal catalyst. By bulk metal, it is meant that the catalysts are unsupported wherein the bulk catalyst particles comprise 30-100 wt. % of at least one Group 8-10 non-noble metal and at least one Group 6 metal, based on the total weight of the bulk catalyst particles, calculated as metal oxides and wherein the bulk catalyst particles have a surface area of at least 10 m²/g. It is furthermore preferred that the bulk metal hydrotreating catalysts used herein comprise 50 to 100 wt %, and even more preferably 70 to 100 wt %, of at least one Group 8-10 non-noble metal and at least one Group 6 metal, based on the total weight of the particles, calculated as metal oxides. The amount of Group 6 and Group 8-10 non-noble metals can easily be determined VIB TEM-EDX.

Bulk catalyst compositions comprising one Group 8-10 non-noble metal and two Group 6 metals are preferred. It has been found that in this case, the bulk catalyst particles are sintering-resistant. Thus the active surface area of the bulk catalyst particles is maintained during use. The molar ratio of Group 6 to Group 8-10 non-noble metals ranges generally from 10:1-1:10 and preferably from 3:1-1:3, In the case of a core-shell structured particle, these ratios of course apply to the metals contained in the shell. If more than one Group 6 metal is contained in the bulk catalyst particles, the ratio of the different Group 6 metals is generally not critical. The same holds when more than one Group 8-10 non-noble metal is applied. In the case where molybdenum and tungsten are present as Group 6 metals, the molybenum:tungsten ratio preferably lies in the range of 9:1-1:9. Preferably the Group 8-10 non-noble metal comprises nickel and/or cobalt. It is further preferred that the Group 6 metal comprises a combination of molybdenum and tungsten. Preferably, combinations of nickel/molybdenum/tungsten and cobalt/molybdenum/tungsten and nickel/cobalt/molybdenum/tungsten are used. These types of precipitates appear to be sinter-resistant. Thus, the active surface area of the precipitate is maintained during use. The metals are preferably present as oxidic compounds of the corresponding metals, or if the catalyst composition has been sulfided, sulfidic compounds of the corresponding metals.

In some optional aspects, the bulk metal hydrotreating catalysts used herein have a surface area of at least 50 m²/g and more preferably of at least 100 m²/g. In such aspects, it is also desired that the pore size distribution of the bulk metal hydrotreating catalysts be approximately the same as the one of conventional hydrotreating catalysts. Bulk metal hydrotreating catalysts can have a pore volume of 0.05-5 ml/g, or of 0.1-4 ml/g, or of 0.1-3 ml/g, or of 0.1-2 tag determined by nitrogen adsorption. Preferably, pores smaller than 1 nm are not present. The bulk metal hydrotreating catalysts can have a median diameter of at least 50 nm, or at least 100 nm. The bulk metal hydrotreating catalysts can have a median diameter of not more than 5000 μm, or not more than 3000 μm. In an embodiment, the median particle diameter lies in the range of 0.1-50 μm and most preferably in the range of 0.5-50 μm.

### Hydrocracking or Conversion Conditions

In various aspects, instead of using a conventional hydrocracking catalyst in a second (sweet) reaction stage for conversion of a feed, a reaction system can include a high surface area, low acidity conversion catalyst as described herein. In aspects where a lubricant boiling range feed has a sufficiently low content of heteroatoms, such as a feed that corresponds to a “sweet” feed, the feed can be exposed to a high surface area, low acidity conversion catalyst as described herein without prior hydroprocessing to remove heteroatoms.

In various aspects, the conditions selected for conversion for lubricant base stock production can depend on the desired level of conversion, the level of contaminants in the input feed to the conversion stage, and potentially other factors. For example, hydrocracking and/or conversion conditions in a single stage, or in the first stage and/or the second stage of a multi-stage system, can be selected to achieve a desired level of conversion in the reaction system. Hydrocracking and/or conversion conditions can be referred to as sour conditions or sweet conditions, depending on the level of sulfur and/or nitrogen present within a feed and/or present in the gas phase of the reaction environment. For example, a feed with 100 wppm or less of sulfur and 50 wppm or less of nitrogen, preferably less than 25 wppm sulfur and/or less than 10 wppm of nitrogen, represent a feed for hydrocracking and/or conversion under sweet conditions. Feeds with sulfur contents of 250 wppm or more can be processed under sour conditions. Feeds with intermediate levels of sulfur can be processed either under sweet conditions or sour conditions.

In aspects that include hydrocracking as part of an initial hydroprocessing stage under sour conditions, the initial stage hydrocracking catalyst can comprise any suitable or standard hydrocracking catalyst, for example, a zeolitic base selected from zeolite Beta, zeolite X, zeolite Y, faujasite, ultrastable Y (USY), dealuminized Y (Deal Y), Mordenite, ZSM-3, ZSM-4, ZSM-18, ZSM-20, ZSM-48, and combinations thereof, which zeolitic base can advantageously be loaded with one or more active metals (e.g., either (i) a Group 8-10 noble metal such as platinum and/or palladium or (ii) a Group 8-10 non-noble metal such nickel, cobalt, iron, and combinations thereof, and a Group 6 metal such as molybdenum and/or tungsten). In this discussion, zeolitic materials are defined to include materials having a recognized zeolite framework structure, such as framework structures recognized by the International Zeolite Association. Such zeolitic materials can correspond to silicoaluminates, silicoaluminophosphates, aluminophosphates, and/or other combinations of atoms that can be used to form a zeolitic framework structure. In addition to zeolitic materials, other types of crystalline acidic support materials may also be suitable. Optionally, a zeolitic material and/or other crystalline acidic material may be mixed or bound with other metal oxides such as alumina, titania, and/or silica.

In some optional aspects, a high surface area, low acidity conversion catalyst as described herein can optionally be used as part of the catalyst in an initial stage.

A hydrocracking process in a first stage (or otherwise under sour conditions) can be carried out at temperatures of 200° C. to 450° C., hydrogen partial pressures of from 250 psig to 5000 psig (˜1.8 MPag to ˜34.6 MPag), liquid hourly space velocities of from 0.2 h⁻¹ to 10 h⁻¹, and hydrogen treat gas rates of from 35.6 m³/m³ to 1781 m³/m³ (˜200 SCF/B to ˜10,000 SCF/B), Typically, in most cases, the conditions can include temperatures in the range of 300° C. to 450° C., hydrogen partial pressures of from 500 psig to 2000 psig (˜3.5 MPag to ˜13.9 MPag), liquid hourly space velocities of from 0.3 h⁻¹ to 5 h⁻¹ and hydrogen treat gas rates of from 213 m³/m³ to 1068 m³/m³ (˜1200 SCF/B to ˜6000 SCF/B).

In a multi-stage reaction system, a first reaction stage of the hydroprocessing reaction system can include one or more hydrotreating and/or hydrocracking catalysts. A separator can then be used in between the first and second stages of the reaction system to remove gas phase sulfur and nitrogen contaminants. One option for the separator is to simply perform a gas-liquid separation to remove contaminants. Another option is to use a separator such as a flash separator that can perform a separation at a higher temperature. Such a high temperature separator can be used, for example, to separate the feed into a portion boiling below a temperature cut point, such as about 350° F. (177° C.) or about 400° F. (204° C.), and a portion boiling above the temperature cut point. In this type of separation, the naphtha boiling range portion of the effluent from the first reaction stage can also be removed, thus reducing the volume of effluent that is processed in the second or other subsequent stages. Of course, any low boiling contaminants in the effluent from the first stage would also be separated into the portion boiling below the temperature cut point. If sufficient contaminant removal is performed in the first stage, the second stage can be operated as a “sweet” or low contaminant stage.

Still another option can be to use a separator between the first and second stages of the hydroprocessing reaction system that can also perform at least a partial fractionation of the effluent from the first stage. In this type of aspect, the effluent from the first hydroprocessing stage can be separated into at least a portion boiling below the distillate (such as diesel) fuel range, a portion boiling in the distillate fuel range, and a portion boiling above the distillate fuel range. The distillate fuel range can be defined based on a conventional diesel boiling range, such as having a lower end cut point temperature of at least about 350° F. (177° C.) or at least about 400° F. (204° C.) to having an upper end cut point temperature of about 700° F. (371° C.) or less or 650° F. (343° C.) or less. Optionally, the distillate fuel range can be extended to include additional kerosene, such as by selecting a lower end cut point temperature of at least about 300° F. (149° C.).

In aspects where the inter-stage separator is also used to produce a distillate fuel fraction, the portion boiling below the distillate fuel fraction includes, naphtha boiling range molecules, light ends, and contaminants such as H₂S. These different products can be separated from each other in any convenient manner. Similarly, one or more distillate fuel fractions can be formed, if desired, from the distillate boiling range fraction. The portion boiling above the distillate fuel range represents the potential lubricant base stocks. In such aspects, the portion boiling above the distillate fuel boiling range is subjected to further hydroprocessing in a second hydroprocessing stage. The portion boiling above the distillate fuel boiling range can correspond to a lubricant boiling range fraction, such as a fraction having a T5 or T10 boiling point of at least about 343° C. Optionally, the lighter lube fractions can be distilled and operated in the catalyst dewaxing sections in a blocked operation where the conditions are adjusted to maximize the yield and properties of each lube cut.

A conversion process under sweet conditions can be performed under conditions similar to those used for a sour hydrocracking process, or the conditions can be different. In an embodiment, the conditions in a sweet conversion stage can have less severe conditions than a hydrocracking process in a sour stage. Suitable conversion conditions for a non-sour stage can include, but are not limited to, conditions similar to a first or sour stage. Suitable conversion conditions can include temperatures of about 550° F. (288° C.) to about 840° F. (449° C.), hydrogen partial pressures of from about 1000 psia to about 5000 psia (˜6.9 MPa-a to 34.6 MPa-a), liquid hourly space velocities of from 0.05 h⁻¹ to 10 h⁻¹, and hydrogen treat gas rates of from 35.6 m³/m³ to 1781 m³/m³ (200 SCF/B to 10,000 SCF/B). In other embodiments, the conditions can include temperatures in the range of about 600° F. (343° C.) to about 815° F. (435° C.), hydrogen partial pressures of from about 1000 psia to about 3000 psia (˜6.9 MPa-a to 20.9 MPa-a), and hydrogen treat gas rates of from about 213 m³/m³ to about 1068 m³/m³ (1200 SCF/B to 6000 SCF/B). The LHSV can be from about 0.25 h⁻¹ to about 50 h⁻¹, or from about 0.5 h⁻¹ to about 20 h⁻¹, and preferably from about 1.0 h⁻¹ to about 4.0 h⁻¹.

In still another aspect, the same conditions can be used for hydrotreating, hydrocracking, and/or conversion beds or stages, such as using hydrotreating conditions for all beds or stages, using hydrocracking conditions for all beds or stages, and/or using conversion conditions for all beds or stages. In yet another embodiment, the pressure for the hydrotreating, hydrocracking, and/or conversion beds or stages can be the same.

In yet another aspect, a hydroprocessing reaction system may include more than one hydrocracking and/or conversion stage. If multiple hydrocracking and/or conversion stages are present, at least one hydrocracking stage can have effective hydrocracking conditions as described above, including a hydrogen partial pressure of at least about 1000 psia (˜6.9 MPa-a). In such an aspect, other (subsequent) conversion processes can be performed under conditions that may include lower hydrogen partial pressures. Suitable conversion conditions for an additional conversion stage can include, but are not limited to, temperatures of about 550° F. (288° C.) to about 840° F. (449° C.), hydrogen partial pressures of from about 250 psia to about 5000 psia (1.8 MPa-a to 34.6 MPa-a), liquid hourly space velocities of from 0.05 h⁻¹ to 10 h⁻¹, and hydrogen treat gas rates of from 35.6 m³/m³ to 1781 m³/m³ (200 SCF/B to 10,000 SCF/B). In other embodiments, the conditions for an additional conversion stage can include temperatures in the range of about 600° F. (343° C.) to about 815° F. (435° C.), hydrogen partial pressures of from about 500 psia to about 3000 psia (3.5 MPa-a to 20.9 MPa-a), and hydrogen treat gas rates of from about 213 m³/m³ to about 1068 m³/m³ (1200 SCF/B to 6000 SCF/B). The LHSV can be from about 0.25 h⁻¹ to about 50 h⁻¹, or from about 0.5 h⁻¹ to about 20 h⁻¹, and preferably from about 1.0 h⁻¹ to about 4.0 h⁻¹.

### Additional Second Stage Processing—Dewaxing and Hydrofinishing/Aromatic Saturation

In various aspects, catalytic dewaxing can be included as part of a second and/or sweet and/or subsequent processing stage, such as a processing stage that also includes conversion in the presence of a high surface area, low acidity catalyst. Preferably, the dewaxing catalysts are zeolites (and/or zeolitic crystals) that perform dewaxing primarily by isomerizing a hydrocarbon feedstock. More preferably, the catalysts are zeolites with a unidimensional pore structure. Suitable catalysts include 10-member ring pore zeolites, such as EU-1, ZSM-35 (or ferrierite), ZSM-11, ZSM-57, NU-87, SAPO-11, and ZSM-22. Preferred materials are EU-2, EU-11, ZBM-30, ZSM-48, or ZSM-23. ZSM-48 is most preferred. Note that a zeolite having the ZSM-23 structure with a silica to alumina ratio of from 20:1 to 40:1 can sometimes be referred to as SSZ-32. Other zeolitic crystals that are isostructural with the above materials include Theta-1, NU-10, EU-13, KZ-1, and NU-23.

In various embodiments, the dewaxing catalysts can further include a metal hydrogenation component. The metal hydrogenation component is typically a Group 6 and/or a Group 8-10 metal. Preferably, the metal hydrogenation component is a Group 8-10 noble metal. Preferably, the metal hydrogenation component is Pt, Pd, or a mixture thereof. In an alternative preferred embodiment, the metal hydrogenation component can be a combination of a non-noble Group 8-10 metal with a Group 6 metal. Suitable combinations can include Ni, Co, or Fe with Mo or W, preferably Ni with Mo or W.

The metal hydrogenation component may be added to the dewaxing catalyst in any convenient manner. One technique for adding the metal hydrogenation component is by incipient wetness. For example, after combining a zeolite and a binder, the combined zeolite and binder can be extruded into catalyst particles. These catalyst particles can then be exposed to a solution containing a suitable metal precursor. Alternatively, metal can be added to the catalyst by ion exchange, where a metal precursor is added to a mixture of zeolite (or zeolite and binder) prior to extrusion.

The amount of metal in the dewaxing catalyst can be at least 0.1 wt % based on catalyst, or at least 0.15 wt %, or at least 0.2 wt %, or at least 0.25 wt %, or at least 0.3 wt %, or at least 0.5 wt % based on catalyst. The amount of metal in the catalyst can be 20 wt % or less based on catalyst, or 10 wt % or less, or 5 wt % or less, or 2.5 wt % or less, or 1 wt % or less. For aspects where the metal is Pt, Pd, another Group 8-10 noble metal, or a combination thereof, the amount of metal can be from 0.1 to 5 wt %, preferably from 0.1 to 2 wt %, or 0.25 to 1.8 wt %, or 0.4 to 1.5 wt %. For aspects where the metal is a combination of a non-noble Group 8-10 metal with a Group 6 metal, the combined amount of metal can be from 0.5 wt % to 20 wt %, or 1 wt % to 15 wt %, or 2.5 wt % to 10 wt %.

Preferably, a dewaxing catalyst can be a catalyst with a low ratio of silica, to alumina. For example, for ZSM-48, the ratio of silica to alumina in the zeolite can be less than 200:1, or less than 110:1, or less than 100:1, or less than 90:1, or less than 80:1. In particular, the ratio of silica to alumina can be from 30:1 to 200:1, or 60:1 to 110:1, or 70:1 to 100:1.

A dewaxing catalyst can also include a binder. In some embodiments, the dewaxing catalysts used in process according to the invention are formulated using a low surface area binder, a low surface area binder represents a binder with a surface area of 100 m²/g or less, or 80 m²/g or less, or 70 m²/g or less, such as down to 40 m²/g or still lower.

Alternatively, the binder and the zeolite particle size can be selected to provide a catalyst with a desired ratio of micropore surface area to total surface area. In dewaxing catalysts used according to the invention, the micropore surface area corresponds to surface area from the unidimensional pores of zeolites in the dewaxing catalyst. The total surface corresponds to the micropore surface area plus the external surface area. Any binder used in the catalyst will not contribute to the micropore surface area and will not significantly increase the total surface area of the catalyst. The external surface area represents the balance of the surface area of the total catalyst minus the micropore surface area. Both the binder and zeolite can contribute to the value of the external surface area. Preferably, the ratio of micropore surface area to total surface area for a dewaxing catalyst will be equal to or greater than 25%.

A zeolite (or other zeolitic material) can be combined with binder in any convenient manner. For example, a bound catalyst can be produced by starting with powders of both the zeolite and binder, combining and mulling the powders with added water to form a mixture, and then extruding the mixture to produce a bound catalyst of a desired size. Extrusion aids can also be used to modify the extrusion flow properties of the zeolite and binder mixture. Optionally, a binder can be composed of two or more metal oxides can also be used.

Process conditions in a catalytic dewaxing zone can include a temperature of from 200 to 450° C., preferably 270 to 400° C., a hydrogen partial pressure of from 1.8 to 34.6 MPag (˜250 to ˜5000 psi), preferably 4.8 to 20.8 MPag, a liquid hourly space velocity of from 0.2 to 10 hr⁻¹, preferably 0.5 to 3.0 hr⁻¹, and a hydrogen circulation rate of from 35.6 to 1781 m³/m³ (˜200 to ˜10,000 SCF/B), preferably 178 to 890.6 m³/m³ (˜1000 to ˜5000 scf/B). Additionally or alternately, the conditions can include temperatures in the range of 600° F. (˜343° C.) to 815° F. (˜435° C.), hydrogen partial pressures of from 500 psig to 3000 psig (˜3.5 MPag to ˜20.9 MPag), and hydrogen treat gas rates of from 213 m³/m³ to 1068 m³/m³ (˜1200 SCF/B to ˜6000 SCF/B).

In various aspects, a hydrofinishing and/or aromatic saturation process can also be provided. The hydrofinishing and/or aromatic saturation can occur prior to dewaxing and/or after dewaxing. The hydrofinishing and/or aromatic saturation can occur either before or after fractionation. If hydrofinishing and/or aromatic saturation occurs after fractionation, the hydrofinishing can be performed on one or more portions of the fractionated product, such as being performed on one or more lubricant base stock portions. Alternatively, the entire effluent from the last conversion or dewaxing process can be hydrofinished and/or undergo aromatic saturation.

In some situations, a hydrofinishing process and an aromatic saturation process can refer to a single process performed using the same catalyst. Alternatively, one type of catalyst or catalyst system can be provided to perform aromatic saturation, while a second catalyst or catalyst system can be used for hydrofinishing. Typically a hydrofinishing and/or aromatic saturation process will be performed in a separate reactor from dewaxing or hydrocracking processes for practical reasons, such as facilitating use of a lower temperature for the hydrofinishing or aromatic saturation process. However, an additional hydrofinishing reactor following a hydrocracking or dewaxing process but prior to fractionation could still be considered part of a second stage of a reaction system conceptually.

Hydrofinishing and/or aromatic saturation catalysts can include catalysts containing Group 6 metals, Group 8-10 metals, and mixtures thereof. In an embodiment, preferred metals include at least one metal sulfide having a strong hydrogenation function. In another embodiment, the hydrofinishing catalyst can include a Group 8-10 noble metal, such as Pt, Pd, or a combination thereof The mixture of metals may also be present as bulk metal catalysts wherein the amount of metal is 30 wt. % or greater based on catalyst. Suitable metal oxide supports include low acidic oxides such as silica, alumina, silica-aluminas or titania, preferably alumina. The preferred hydrofinishing catalysts for aromatic saturation will comprise at least one metal having relatively strong hydrogenation function on a porous support. Typical support materials include amorphous or crystalline oxide materials such as alumina, silica, and silica-alumina. The support materials may also be modified, such as by halogenation, or in particular fluorination. The metal content of the catalyst is often as high as 20 weight percent for non-noble metals. In an embodiment, a preferred hydrofinishing catalyst can include a crystalline material belonging to the M41S class or family of catalysts. The M41S family of catalysts are mesoporous materials having high silica content. Examples include MCM-41, MCM-48 and MCM-50. A preferred member of this class is MCM-41. If separate catalysts are used for aromatic saturation and hydrofinishing, an aromatic saturation catalyst can be selected based on activity and/or selectivity for aromatic saturation, while a hydrofinishing catalyst can be selected based on activity for improving product specifications, such as product color and polynuclear aromatic reduction.

Hydrofinishing conditions can include temperatures from 125° C. to 425° C., preferably 180° C. to 280° C., total pressures from 500 psig (˜3.4 MPag) to 3000 psig (˜20.7 MPag), preferably 1500 psig (˜10.3 MPag) to 2500 psig (˜17.2 MPag), and liquid hourly space velocity (LHSV) from 0.1 hr⁻¹ to 5 hr⁻¹, preferably 0.5 hr⁻¹ to 1.5 hr⁻¹.

A second fractionation or separation can be performed at one or more locations after a second or subsequent stage. In some aspects, a fractionation can be performed after hydrocracking in the second stage in the presence of the USY catalyst under sweet conditions. At least a lubricant boiling range portion of the second stage hydrocracking effluent can then be sent to a dewaxing and/or hydrofinishing reactor for further processing. In some aspects, hydrocracking and dewaxing can be performed prior to a second fractionation. In some aspects, hydrocracking, dewaxing, and aromatic saturation can be performed prior to a second fractionation. Optionally, aromatic saturation and/or hydrofinishing can be performed before a second fractionation, after a second fractionation, or both before and after.

### EXAMPLES

In the following examples, the activity of various catalysts is shown for feed conversion, VI uplift, and aromatics saturation. The examples are based on processing using seven different types of catalysts.

Catalyst A: 0.9 wt % Pd/0.3 wt % Pt on MCM-41, bound with Versal-300 alumina. The MCM-41 had a 50:1 ratio of silica to alumina (SiO₂:Al₂O₃). Catalyst A had an average pore size of 30 Angstroms. The weight ratio of MCM-41 to alumina binder was 65:35. Catalyst A had a total surface area of greater than 500 m²/g and an Alpha value less than 20.

Catalyst B: 0.6 wt % Pt on MCM-41, bound with Versal-300 alumina. The MCM-41 had a 50:1 ratio of silica to alumina (SiO₂:Al₂O₃). Catalyst B had an average pore size of 40 Angstroms. The weight ratio of MCM-41 to alumina binder was 65:35. Catalyst B had a total surface area of roughly 500 m²/g and an Alpha value less than 20. The total surface corresponded to roughly 200 m²/g of micropore surface area and roughly 300 m²/g of external surface area.

Catalyst C: 0.6 wt % Pt on MCM-41, bound with Versal-300 alumina. The MCM-41 had a 25:1 ratio of silica to alumina (SiO₂:Al₂O₃). Catalyst C had an average pore size of 25 Angstroms. The weight ratio of MCM-41 to alumina binder was 65:35. The bound MCM-41 for Catalyst C (prior to inclusion of Pt) had a total surface area of roughly 1000 m²/g, including roughly 900 m²/g of micropore surface area. It is believed that Catalyst C (after inclusion of Pt) had a total surface area of greater than 700 m²/g and an Alpha value less than 20.

Catalyst D: 0.6 wt % Pt on MCM-41, bound with Versal-300 alumina. The MCM-41 had a 50:1 ratio of silica to alumina (SiO₂: Al₂O₃). Catalyst D had an average pore size of 60 Angstroms. The weight ratio of MCM-41 to alumina binder was 65:35. The bound MCM-41 for Catalyst D (prior to inclusion of Pt) had a surface area of roughly 850 m²/g. It is believed that Catalyst D (after inclusion of Pt) had a surface area of greater than 600 m²/g and an Alpha value less than 20.

Catalyst E: 0.6 wt % Pt on amorphous silica-alumina with a ratio of silica to alumina (SiO₂:Al₂O₃) of roughly 5. A separate binder was not used. Catalyst E had a surface area of roughly 450 m²/g and an Alpha value less than 20.

Catalyst F: 0.6 wt % Pt on USY, bound with Versal-300 alumina. The USY had a ratio of silica to alumina (SiO₂:Al₂O₃) of roughly 75:1. USY is a zeolite with 12-member ring pore channels. The weight ratio of USY to alumina binder was 65:35. Catalyst F had a surface area of roughly 600 m²/g, including about 400 m²/g of micropore surface area and about 200 m²/g of external surface area, and an Alpha value less than 20. The effective pore size of Catalyst F is based on the 12-member ring pore channels of the USY.

Catalyst G: 0.6 wt % Pt on MCM-41/USY in a weight ratio of MCM-41 to USY of 50:15, bound with Versal-300 alumina. The MCM-41 was similar to the MCM-41 used for Catalyst B. The USY was similar to the USY used for Catalyst F. The weight ratio of combined MCM-41 and USY to binder was 65:35. Catalyst G had a surface area of roughly 500 m²/g, including a micropore surface area of less than 100 m²/g and an external surface area of greater than 400 m²/g, and an Alpha value less than 20. Due to a low micropore volume, the pore size peak associated with the USY pore channels corresponds to less than 10% of the pore volume. As a result, the effective pore size of Catalyst G is greater than 8.0 Angstroms.

The activity of the above catalysts was investigated using three types of feeds. Table 1 shows the three types of feeds. Feeds 1 and 2 correspond to hydrotreated and/or hydrocracked bottoms fractions. Feed 3 corresponds to a hydrotreated deasphalted oil from a propane deasphalting process. It is noted that the aromatics content of the deasphalted oil in Feed 3 was substantially lower than the aromatics content of the hydrocracked bottoms fractions corresponding to Feed 1 or Feed 2. For the dry wax amount, the amount of dry wax was corrected to the expected value at a pour point of −18° C. based on a correction of −0.33 wt %/° C. of pour point. For the viscosity index, the viscosity index was corrected to the expected value at a pour point of −18° C. based on a correction of 0.33 VI/° C. of pour point.

TABLE 1
Feed Properties

| | Feed 1 | Feed 2 | Feed 3 |
|---|---|---|---|
| Sulfur (wppm) | 27 | 22 | 21 |
| Nitrogen (wppm) | 1 | 1 | 1 |
| Total Aromatics | >35 wt % | >35 wt % | <25 wt % |
| Dry Wax @-18° C. Pour Pt (wt %) | 18.4 | 15.7 | 19.6 |
| Solvent Dewaxed Oil | | | |
| Kinematic Viscosity @100° C. | 4.9 | 11.3 | 20.9 |
| (cSt) | | | |
| Pour Point (° C.) | −16 | −16 | −12 |
| Viscosity Index | 107.3 | 87.6 | 98.5 |
| Viscosity Index @-18° C. Pour Pt | 107.6 | 89.9 | 97.5 |

### Example 1

### Viscosity Index Versus Conversion

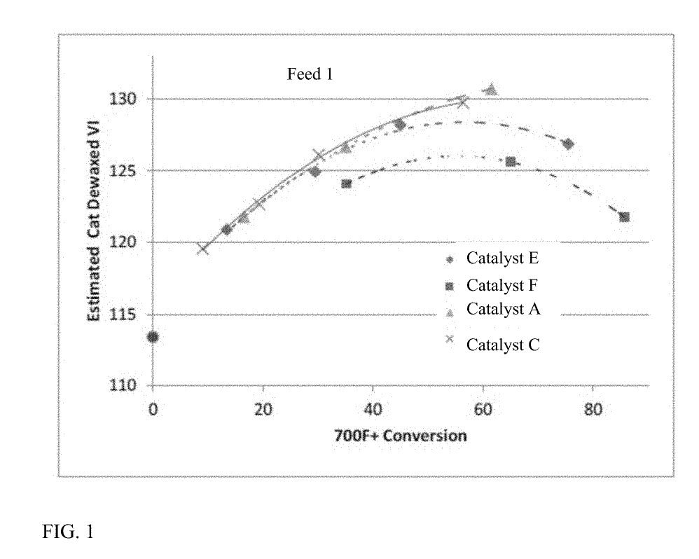

FIGS. 1 to 5 show results for estimated viscosity index relative to the amount of 371° C.+ conversion for various combinations of feed and catalyst. The estimated viscosity index represents the estimated viscosity index based on performing sufficient catalytic dewaxing to achieve a target pour point of −18° C. In each processing run to generate a data point, the conditions were adjusted to generate the indicated amount of feed conversion for each catalyst.

In FIG. 1, Feed 1 from Table 1 was processed in the presence of Catalysts A, C, E, and F. As shown in FIG. 1, processing of Feed 1 in the presence of Catalysts A, C, and E resulted in a hydrocracked product with an estimated viscosity index that was roughly 2 to 5 numbers higher than the viscosity index of the hydrocracked product generated by Catalyst F.

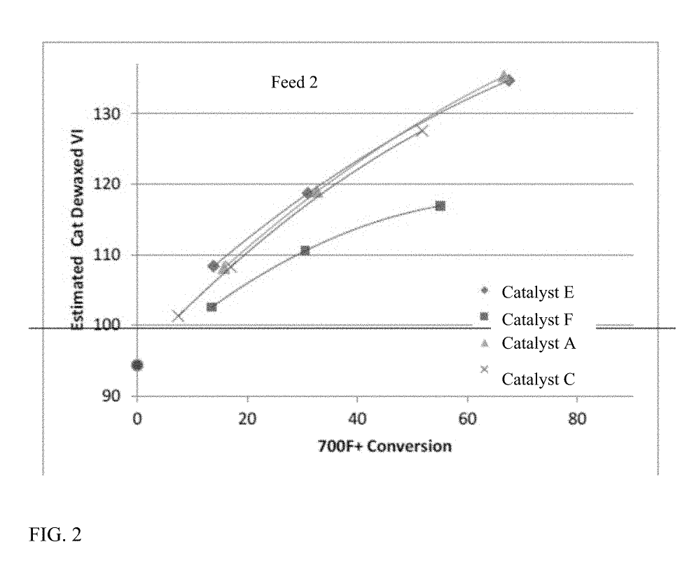

In FIG. 2, Feed 2 from Table 1 was processed in the presence of Catalysts A, C, E, and F. As shown in FIG. 2, processing of Feed 2 in the presence of Catalysts A, C, and E resulted in a hydrocracked product with a higher estimated viscosity index than the viscosity index of the hydrocracked product generated by Catalyst F. At 371° C.+ conversion amounts of 20 wt % or less, the amount of additional VI increase was roughly 2 to 5. The amount of additional VI increase was greater as the amount of 371° C.+ conversion increased, with additional VI increases of 10 or more at roughly 60 wt % conversion relative to 371° C. The results in FIG. 2 appear to show that for feeds that start with a lower initial viscosity index, the benefit of using a high surface area, low acidity catalyst can increase with increasing feed conversion.

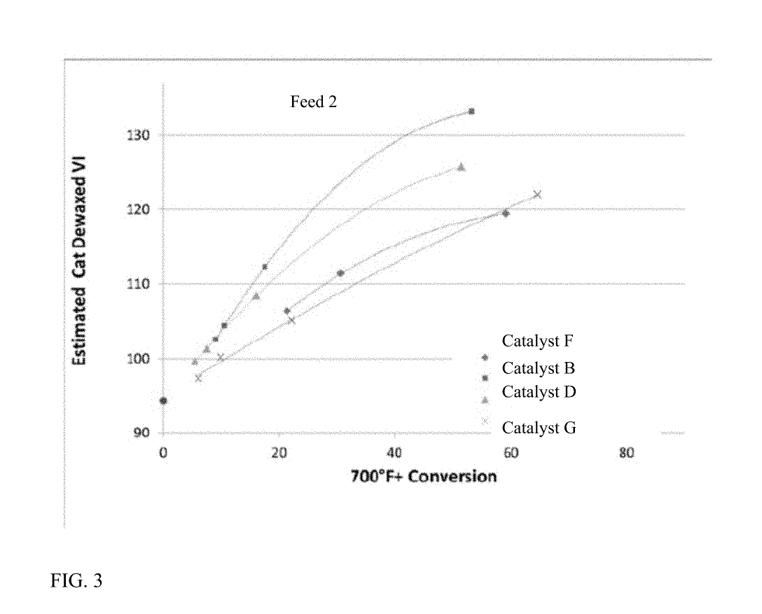

In FIG. 3, Feed 2 from Table 1 was processed in the presence of Catalysts B, D, F, and G. As shown in FIG. 3, processing of Feed 2 in the presence of Catalysts B and D resulted in a hydrocracked product with a higher estimated viscosity index than the viscosity index of the hydrocracked products generated by Catalysts F and G. At 371° C.+ conversion amounts of 20 wt % or less, the amount of additional VI increase was roughly 2 to 5. The amount of additional VI increase was greater as the amount of 371° C.+ conversion increased, with additional VI increases of 10 or more at roughly 60 wt % conversion relative to 371° C. The results in FIG. 2 appear to show that for feeds that start with a lower initial viscosity index, the benefit of using a high surface area, low acidity catalyst can increase with increasing feed conversion. Additionally, FIG. 3 appears to show the Catalyst G provides slightly less increase in viscosity index relative to Catalyst F for the range of 371° C.+ conversion amounts shown in FIG. 3.

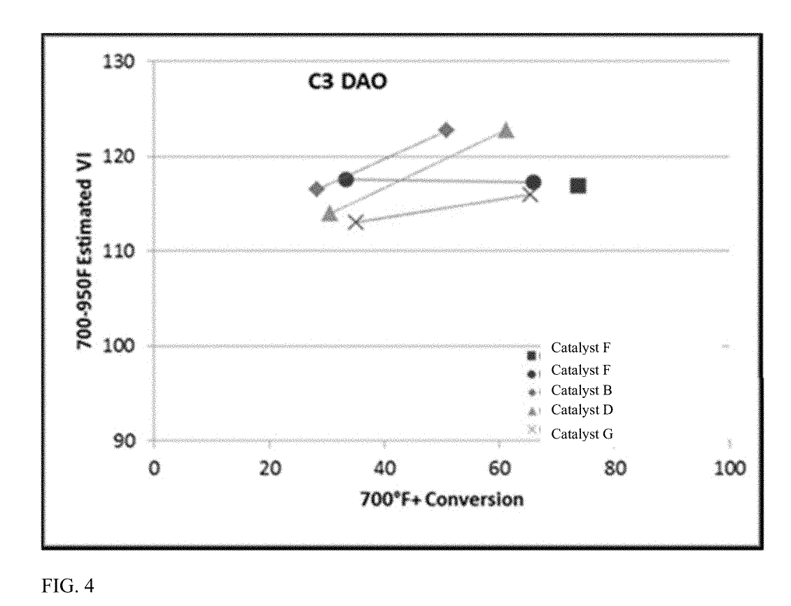

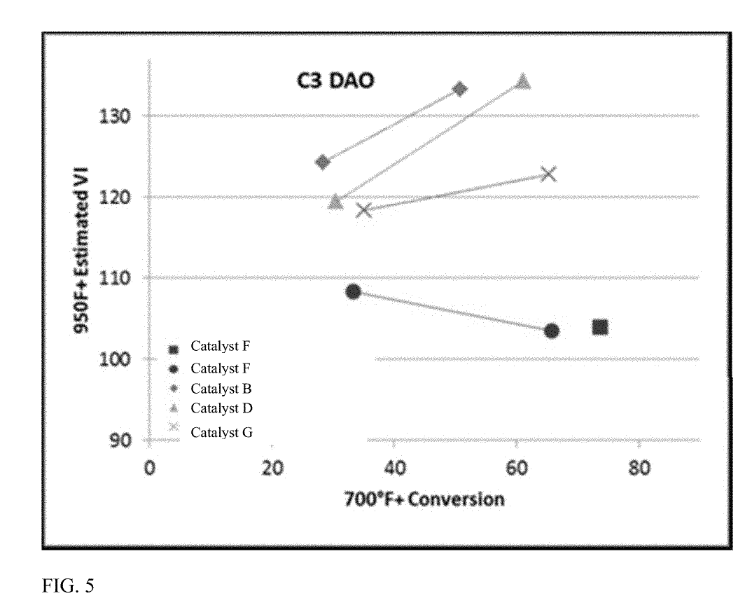

FIGS. 4 and 5 show results from processing Feed 3 from Table 1 in the presence of Catalysts A, C, F, and G. FIG. 4 corresponds to results for 371° C.-510° C. portions of the converted or hydrocracked deasphalted oil product, while FIG. 5 corresponds to results for 510° C.+ portions of the converted or hydrocracked deasphalted oil product. For conversion or hydrocracking of deasphalted oil, FIG. 4 appears to show that processing over a high surface area, low acidity catalyst can provide additional viscosity index uplift with increasing conversion, while processing over conventional hydrocracking Catalyst F actually results in a slight decrease in viscosity index uplift with increasing conversion. As a result, a high surface area, low acidity catalyst can allow for production of a converted, deasphalted oil composition having a viscosity index of at least 110 for the 700° F.-950° F. (371° C.-510° C.) portion of the composition. These trends appear to be more pronounced in FIG. 5, which shows the estimated viscosity index for the heavier portion of the converted or hydrocracked deasphalted oil products. As a result, a high surface area, low acidity catalyst can allow for production of a converted, deasphalted oil composition that includes a 950° F.+ (510° C.+) portion having a viscosity index of 115-140, with the viscosity index of the 510° C.+ portion being greater than the viscosity index of the 371° C.-510° C. portion. Due to the lower aromatics content of Feed 3, FIG. 5 appears to show that Catalyst G provides viscosity index uplift that is in between the uplift of (conversion) Catalysts A and C and (hydrocracking catalyst) F. However, for the lower boiling portion of the converted deasphalted oil in FIG. 4, Catalyst G appears to be similar or slightly less effective than Catalyst F.

### Example 2

### Aromatic Saturation

In addition to providing an increased amount of viscosity index uplift relative to the amount of 371° C.+ conversion, the high surface area, low acidity conversion catalysts described herein can also provide improved aromatic saturation relative to conventional hydrocracking catalysts. This can be observed both for the total aromatics in a converted product and for the 3+ ring aromatics.

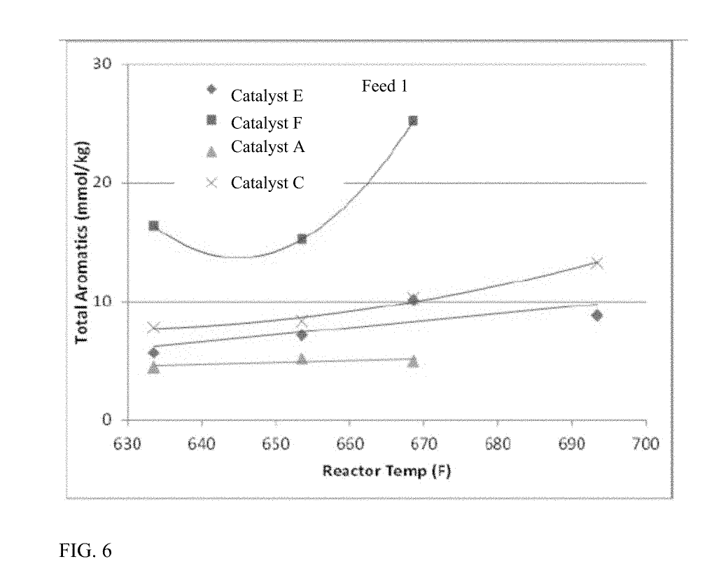

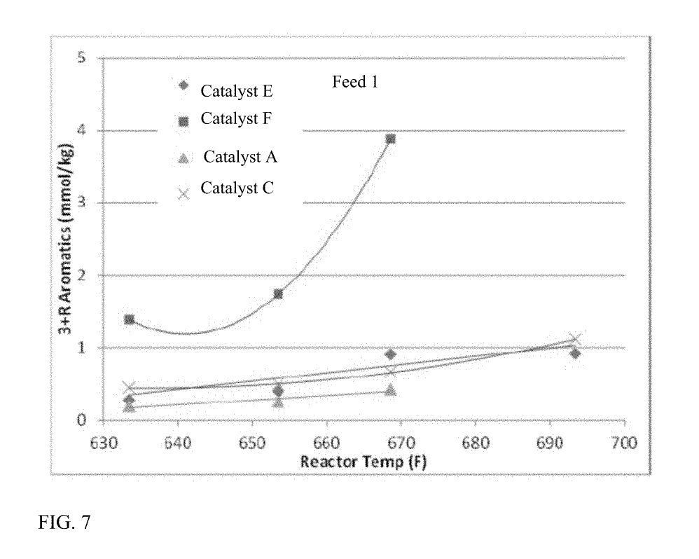

FIGS. 6 and 7 show the total aromatics content and 3+ ring aromatics content for the converted or hydrocracked effluents generated during the processing runs shown in FIG. 1. As shown in FIG. 6, converting Feed 1 from Table 1 in the presence of Catalyst A, C, or E provides improved aromatic saturation relative to temperature as compared with hydrocracking in the presence of Catalyst F. It is noted that the aromatics in the effluents from Catalysts A, C, and E are substantially lower than the aromatics in the effluent from Catalyst F at all processing temperatures shown in FIG. 6. Thus, even though processing at constant conversion can require a higher temperature for Catalysts A, C, or E, the resulting effluent at constant 371° C.+ conversion can still have a reduced aromatics content as compared to the effluent from processing with Catalyst F. Additionally, it appears that for temperatures above 350° C., the aromatics content in the hydrocracked effluent produced by Catalyst F starts to increase sharply with temperature. This is in contrast to the relatively modest increases in aromatics with temperature shown for Catalysts A, C, and E. FIG. 7 shows that the 3+ ring aromatic concentration in the converted effluents appears to follow a similar pattern to the total aromatics.

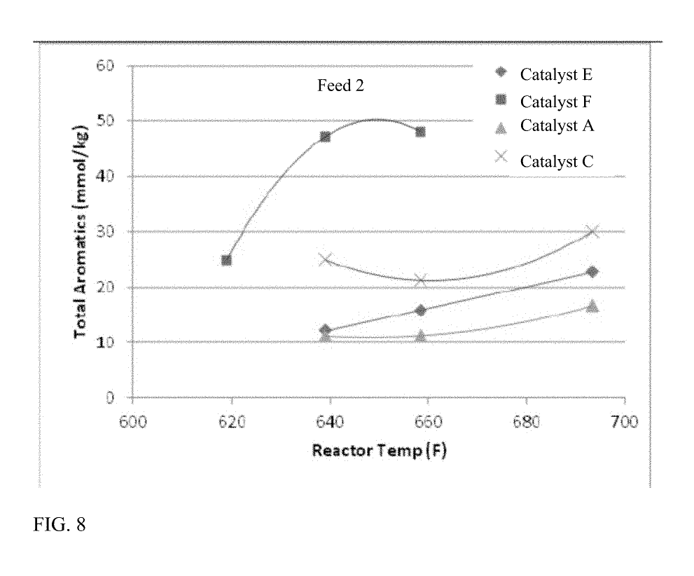

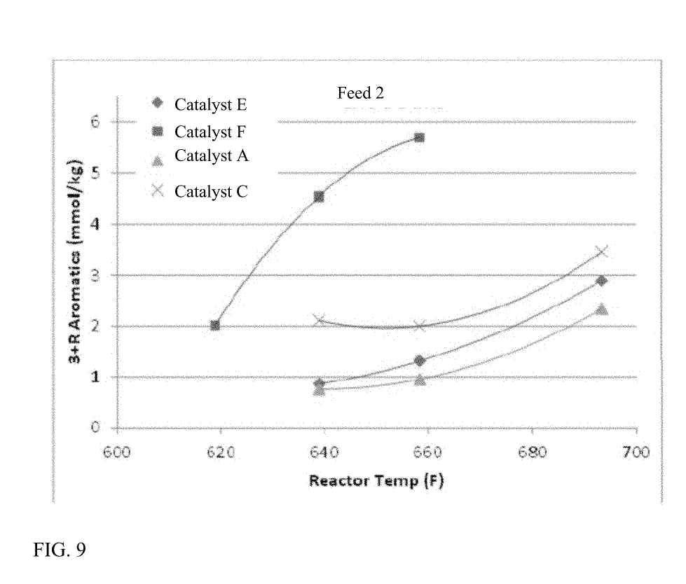

FIGS. 8 and 9 show the total aromatics and 3+ ring aromatics concentrations in the converted or hydrocracked effluents from processing Feed 2 from Table 1 in the presence of Catalysts A, C, E, and F. Similar to the results from processing of Feed 1, FIGS. 8 and 9 appear to show that Catalysts A, C, and E provide an advantage for reducing total and 3+ ring aromatics when processing Feed 2. FIG. 9 may also show that the effluent from processing with Catalyst F can continue to have increasing 3+ ring aromatic content as temperature increases.

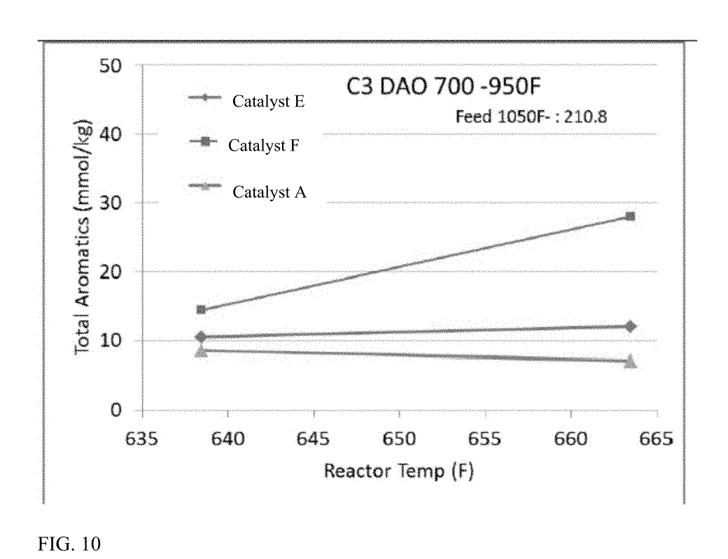

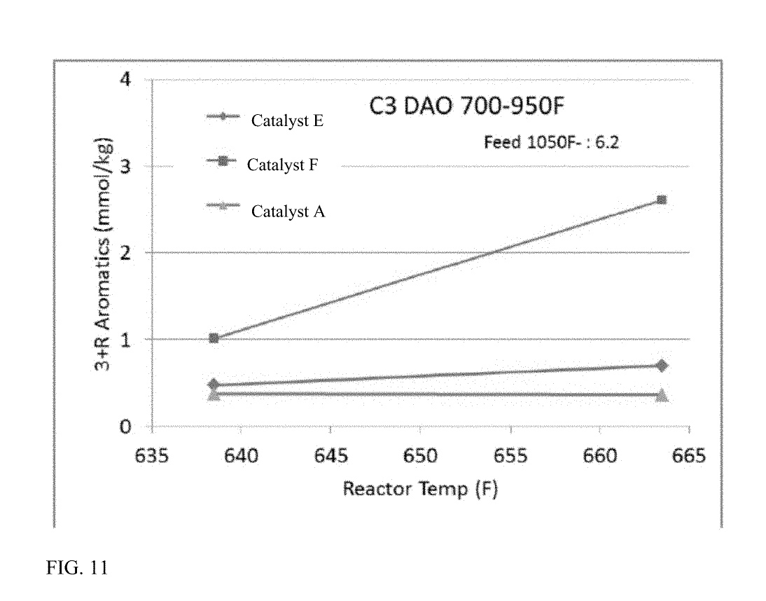

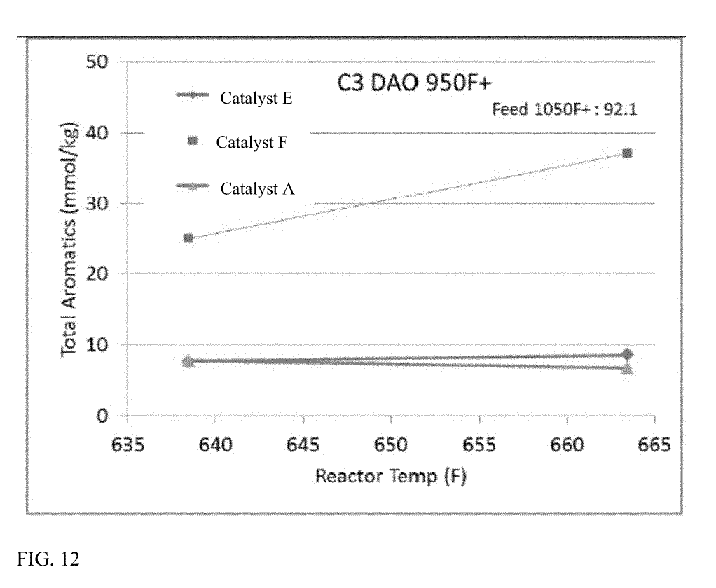

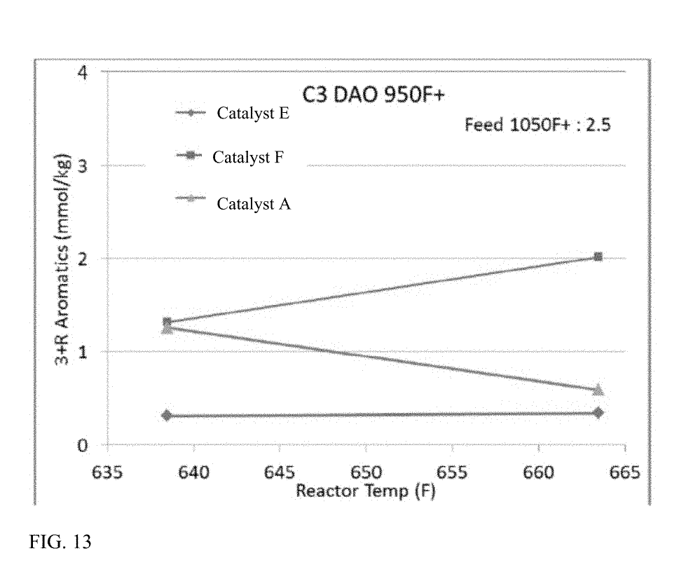

FIGS. 10 and 11 show the total and 3+ ring aromatics contents for the 371° C.-510° C. portions of the converted effluent from processing deasphalted oil in the presence of Catalysts A, C, and F. For a DAO type feed, FIGS. 10 and 11 appear to show that a conventional hydrocracking catalyst (Catalyst F) results in increasing total and 3+ ring aromatics content as a function of temperature. By contrast, the total and 3+ ring aromatics content in the effluents from processing with the high surface area, low acidity catalysts (Catalyst A and C) is relatively constant as a function of temperature. The total aromatics content for the 371° C.-510° C. portion can be about 0.5 wt % or less, while the 3+ ring aromatics content can be about 0.1 wt % or less. Similar relationships can also be observed for the 510° C.+ portions of the hydrocracked deasphalted oil, as shown in FIGS. 12 and 13. The total aromatics content for the 510° C.+portion can be about 0.5 wt % or less, while the 3+ ring aromatics content can be about 0.1 wt % or less.

### Additional Embodiments

Embodiment 1. A method for producing a lubricant boiling range product, comprising: converting a feedstock comprising a lubricant boiling range portion in the presence of a conversion catalyst under conversion conditions to form a converted effluent, the conversion catalyst comprising a surface area of at least 200 m²/g, an Alpha value of 20 or less, and an effective pore size of at least 8.0 Angstroms, the conversion catalyst further comprising 0.01 wt % to 5.0 wt % of a Group 8-10 noble metal supported on the conversion catalyst (or 0.1 wt % to 5.0 wt %); dewaxing at least a portion of the converted effluent under catalytic dewaxing conditions to form a dewaxed effluent; and fractionating at least a portion of the dewaxed effluent to form at least a lubricant boiling range product, and optionally a fuels boiling range product.

Embodiment 2. The method of Embodiment 1, wherein the conversion catalyst comprises a surface area of at least 400 m²/g, or at least 500 m²/g, or at least 600 m²/g, or at least 700 m²/g; or wherein the conversion catalyst comprises an Alpha value of 10 or less; or wherein the conversion catalyst comprises an effective pore size of at least 10 Angstroms, or at least 12 Angstroms; or a combination thereof.

Embodiment 3. The method of any of the above embodiments, wherein the feedstock comprises 50 wppm or less of sulfur (or 25 wppm or less, or 10 wppm or less), or wherein the feedstock comprises 50 wppm or less of nitrogen (or 25 wppm or less, or 10 wppm or less), or a combination thereof.

Embodiment 4. The method of any of the above embodiments, wherein the conversion catalyst is substantially free of crystals having a zeolitic framework; or wherein the conversion catalyst is substantially free of crystals with a 10-member ring pore channel, a 12-member ring pore channel, or a combination thereof.

Embodiment 5. The method of any of the above embodiments, wherein the conversion catalyst comprises a mesoporous material, a mesoporous organosilicate, MCM-41, or a combination thereof.

Embodiment 6. The method of any of the above embodiments, wherein the Group 8-10 noble metal comprises Pt, Pd, or a combination thereof, the conversion catalyst optionally further comprising an additional metal, the optional additional metal comprising Sn, Ga, Zn, Rh, or a combination thereof.

Embodiment 7. The method of any of the above embodiments, wherein the feedstock comprises a hydrotreated deasphalted oil, or wherein the feedstock comprises an aromatics content of about 25 wt % or less, or a combination thereof, the conversion catalyst optionally comprising 0.1 wt % to 25 wt % of crystals having a zeolitic framework (or 0.1 wt % to 15 wt %).

Embodiment 8. The method of any of the above embodiments, further comprising hydrofinishing the dewaxed effluent (or at least a portion thereof) prior to the fractionating.

Embodiment 9. The method of any of the above embodiments, wherein the lubricant boiling range product has an aromatics content of 2.0 wt % or less, a 3+ ring aromatics content of 0.1 wt % or less, or a combination thereof.

Embodiment 10. The method of any of the above embodiments, further comprising hydroprocessing a feed comprising a 650° F.+ (˜343° C.+) portion under first hydroprocessing conditions to form a hydroprocessed effluent; and fractionating at least a portion of the hydroprocessed effluent to form at least a first fuels boiling range fraction and a second fraction, the second fraction comprising the lubricant boiling range portion, the hydroprocessing the feedstock optionally comprising a) exposing the feedstock to a hydrotreating catalyst under hydrotreating conditions, b) exposing the feedstock to a hydrocracking catalyst under hydrocracking conditions, or c) a combination thereof.

Embodiment 11. A system for producing a lubricant boiling range product, comprising: a hydrotreating reactor comprising a hydrotreating feed inlet, a hydrotreating effluent outlet, and at least one fixed catalyst bed comprising a hydrotreating catalyst; a separation stage having a first separation stage inlet and a second separation stage inlet, the first separation stage inlet being in fluid communication with the hydrotreating effluent outlet, the separation stage further comprising a plurality of separation stage liquid effluent outlets, one or more of the separation stage liquid effluent outlets corresponding to product outlets; a conversion reactor comprising a conversion feed inlet, a converted effluent outlet, and at least one fixed catalyst bed comprising a conversion catalyst, the conversion feed inlet being in fluid communication with at least one separation stage liquid effluent outlet, and the conversion catalyst comprising a surface area of at least 200 m²/g (or at least 400 m²/g), an Alpha value of 20 or less, and an effective pore size of at least 8.0 Angstroms, the conversion catalyst further comprising 0.01 wt % to 5.0 wt % of a Group 8-10 noble metal supported on the conversion catalyst (or 0.1 wt % to 5.0 wt %); and a dewaxing reactor comprising a dewaxing feed inlet, a dewaxing effluent outlet, and at least one fixed catalyst bed comprising a dewaxing catalyst, the dewaxing feed inlet being in fluid communication with the converted effluent outlet and being in fluid communication with the dewaxing effluent outlet.

Embodiment 12. The system of Embodiment 11, wherein the dewaxing reactor further comprises a fixed bed comprising a hydrofinishing catalyst, wherein the hydrotreating reactor further comprises a fixed bed comprising a hydrocracking catalyst, or a combination thereof

Embodiment 13. The system of Embodiment 11 or 12, further comprising a hydrofinishing reactor comprising a hydrofinishing feed inlet, a hydrofinishing effluent outlet, and at least one fixed catalyst bed comprising a hydrofinishing catalyst, the hydrofinishing feed inlet being in direct fluid communication with the dewaxing feed outlet, the dewaxing feed inlet being in direct fluid communication with the hydrofinishing effluent outlet and in indirect fluid communication with the dewaxing effluent outlet.

Embodiment 14. The system of any of Embodiments 11 to 13, the system further comprising an additional hydrocracking reactor comprising an additional hydrocracking feed inlet, an additional hydrocracking effluent outlet, and at least one fixed catalyst bed comprising an additional hydrocracking catalyst, the additional hydrocracking reactor providing indirect fluid communication between the hydrotreating effluent outlet and the first separation stage inlet, the additional hydrocracking feed inlet being in fluid communication with the hydrotreating effluent outlet, the additional hydrocracking effluent outlet being in fluid communication with the first separation stage inlet.

Embodiment 15. A lubricant boiling range product made according to the method of any of claims 1-10.

Embodiment 16. A converted, deasphalted oil composition comprising: a 510° C.+ portion having a viscosity index of 115 to 140, a total aromatics content of 0.5 wt % or less, and a 3+ ring aromatics content of 0.1 wt % or less; and a 371° C.-510° C. portion having a viscosity index of at least 110 and that is less than the viscosity index of the 510° C.+ portion, a total aromatics content 0.5 wt % or less, and a 3+ ring aromatics content of 0.1 wt % or less.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

The present invention has been described above with reference to numerous embodiments and specific examples. Many variations will suggest themselves to those skilled in this art in light of the above detailed description. All such obvious variations are within the full intended scope of the appended claims.

1. A method for producing a lubricant boiling range product, comprising:
converting a feedstock comprising a lubricant boiling range portion in the presence of a conversion catalyst under conversion conditions to form a converted effluent, the conversion catalyst comprising a surface area of at least 200 m²/g, an Alpha value of 20 or less, and an effective pore size of at least 8.0 Angstroms, the conversion catalyst further comprising 0.01 wt % to 5.0 wt % of a Group 8-10 noble metal supported on the conversion catalyst;
dewaxing at least a portion of the converted effluent under catalytic dewaxing conditions to form a dewaxed effluent; and
fractionating at least a portion of the dewaxed effluent to form at least a lubricant boiling range product.

2. The method of claim 1, wherein the conversion catalyst comprises a surface area of at least 500 m²/g, or wherein the conversion catalyst comprises an Alpha value of 10 or less, or wherein the conversion catalyst comprises an effective pore size of at least 12 Angstroms, or a combination thereof.

3. The method of claim 1, wherein the conversion catalyst is substantially free of crystals having a zeolitic framework with a 10-member ring pore channel, a 12-member ring pore channel, or a combination thereof.

4. The method of claim 1, wherein the conversion catalyst is substantially free of crystals having a zeolitic framework.

5. The method of claim 1, wherein the conversion catalyst comprises a mesoporous material, a mesoporous organosilicate, or a combination thereof.

6. The method of claim 1, wherein the conversion catalyst comprises MCM-41.

7. The method of claim 1, wherein the Group 8-10 noble metal comprises Pt, Pd, or a combination thereof.

8. The method of claim 7, wherein the conversion catalyst further comprises an additional metal supported on the conversion catalyst, the additional metal comprising Sn, Ga, Zn, Rh, or a combination thereof.

9. The method of claim 1, wherein the feedstock comprises a hydrotreated deasphalted oil, or wherein the feedstock comprises an aromatics content of about 25 wt % or less, or a combination thereof.

10. The method of claim 9, wherein the conversion catalyst comprises 0.1 wt % to 25 wt % of crystals having a zeolitic framework.

11. The method of claim 1, further comprising hydrofinishing the dewaxed effluent prior to the fractionating.

12. The method of claim 1, wherein the lubricant boiling range product has an aromatics content of 2.0 wt % or less, a 3+ ring aromatics content of 0.1 wt % or less, or a combination thereof.

13. The method of claim 1, wherein the feedstock comprises 50 wppm or less of sulfur, 50 wppm or less of nitrogen, or a combination thereof.

14. The method of claim 1, further comprising hydroprocessing a feed comprising a 650° F.+ (˜343° C.+) portion under first hydroprocessing conditions to form a hydroprocessed effluent; and
fractionating at least a portion of the hydroprocessed effluent to form at least a first fuels boiling range fraction and a second fraction, the second fraction comprising the lubricant boiling range portion.

15. The method of claim 14, wherein hydroprocessing the feedstock comprises exposing the feedstock to a hydrotreating catalyst under hydrotreating conditions, or wherein hydroprocessing the feedstock comprises exposing the feedstock to a hydrocracking catalyst under hydrocracking conditions, or a combination thereof.

16. A system for producing a lubricant boiling range product, comprising:
a hydrotreating reactor comprising a hydrotreating feed inlet, a hydrotreating effluent outlet, and at least one fixed catalyst bed comprising a hydrotreating catalyst;
a separation stage having a first separation stage inlet and a second separation stage inlet, the first separation stage inlet being in fluid communication with the hydrotreating effluent outlet, the separation stage further comprising a plurality of separation stage liquid effluent outlets, one or more of the separation stage liquid effluent outlets corresponding to product outlets;
a conversion reactor comprising a conversion feed inlet, a converted effluent outlet, and at least one fixed catalyst bed comprising a conversion catalyst, the conversion feed inlet being in fluid communication with at least one separation stage liquid effluent outlet, and the conversion catalyst comprising a surface area of at least 200 m²/g, an Alpha value of 20 or less, and an effective pore size of at least 8.0 Angstroms, the conversion catalyst further comprising 0.01 wt % to 5.0 wt % of a Group 8-10 noble metal supported on the conversion catalyst; and
a dewaxing reactor comprising a dewaxing feed inlet, a dewaxing effluent outlet, and at least one fixed catalyst bed comprising a dewaxing catalyst, the dewaxing feed inlet being in fluid communication with the converted effluent outlet and being in fluid communication with the dewaxing effluent outlet.

17. The system of claim 16, wherein the dewaxing reactor further comprises a fixed bed comprising a hydrofinishing catalyst; wherein the hydrotreating reactor further comprises a fixed bed comprising a hydrocracking catalyst; or a combination thereof.

18. The system of claim 16, further comprising a hydrofinishing reactor comprising a hydrofinishing feed inlet, a hydrofinishing effluent outlet, and at least one fixed catalyst bed comprising a hydrofinishing catalyst, the hydrofinishing feed inlet being in direct fluid communication with the dewaxing feed outlet, the dewaxing feed inlet being in direct fluid communication with the hydrofinishing effluent outlet and in indirect fluid communication with the dewaxing effluent outlet.

19. The system of claim 16, the system further comprising an additional hydrocracking reactor comprising an additional hydrocracking feed inlet, an additional hydrocracking effluent outlet, and at least one fixed catalyst bed comprising an additional hydrocracking catalyst, the additional hydrocracking reactor providing indirect fluid communication between the hydrotreating effluent outlet and the first separation stage inlet, the additional hydrocracking feed inlet being in fluid communication with the hydrotreating effluent outlet, the additional hydrocracking effluent outlet being in fluid communication with the first separation stage inlet.

20. A converted, deasphalted oil composition comprising:
a 950° F.+ portion having a viscosity index of 115 to 140, a total aromatics content of 0.5 wt % or less, and a 3+ ring aromatics content of 0.1 wt % or less; and
a 700° F.-950° F. portion having a viscosity index of at least 110 and that is less than the viscosity index of the 950° F.+ portion, a total aromatics content 0.5 wt % or less, and a 3+ ring aromatics content of 0.1 wt % or less.
